(19) United States
(12) Patent Application Publication
(10) Pub. No.: US 2008/0070145 A1
(43) Pub. Date: Mar. 20, 2008

(54) Toner, developer, and image forming apparatus

(76) Inventors: Hiroshi Onda, Yamatokoriyama-shi (JP); Yoshinori Yamamoto, Niimi-shi (JP); Masao Suzuki, Shimotsuga-gun (JP)

Correspondence Address: NIXON & VANDERHYE, PC, 901 NORTH GLEBE ROAD, 11TH FLOOR, ARLINGTON, VA, 22203, US

(21) Appl. No.: 11/898,784

(22) Filed: Sep. 14, 2007

(30) Foreign Application Priority Data
Sep. 14, 2006 (JP) P2006-250116

(51) Int. Cl. G03G 9/08

(52) U.S. Cl. 430/110.4

(57) ABSTRACT

There is provided a toner which exhibits a quick rise of charging and excellent cleaning property and which can form high-quality images having high definition and high density. A toner envelope degree of the toner falls in a range of from 2.0 to 3.0, which degree is obtained by calculation of [(L1−L2)/L2]×100 wherein L1 represents a circumference length of a projection image of toner particles containing binder resin and a colorant, and L2 represents a length of envelope of the projection image of the toner particles.

### CROSS-REFERENCE TO RELATED APPLICATION

This application claims priority to Japanese Patent Application No. 2006-250116, which was filed on Sep. 14, 2006, the contents of which are incorporated herein by reference in its entirety.

### BACKGROUND OF THE INVENTION

1. Field of the Invention

The present invention relates to a toner, a developer, and an image forming apparatus.

2. Description of the Related Art

Electrophotographic image forming apparatuses have been widely used as copiers so far, and in recent days, also as printers, facsimile machines, and the like equipments along with spread of computers since the electrophotographic image forming apparatuses operate excellently as output units for computer images created by computers. In a general electrophotographic image forming apparatus, a desired image is formed on a recording medium through a charging step, an exposing step, a developing step, a transferring step, a fixing step, and a cleaning step. At the charging step, a photosensitive layer on a surface of photoreceptor drum is homogeneously charged. At the exposing step, the photosensitive layer on the surface of photoreceptor drum is irradiated with signal light corresponding to an original image so that an electrostatic latent image is formed. At the developing step, an electrophotographic toner (hereinafter referred to simply as “a toner”) is supplied to the electrostatic latent image on the surface of photoreceptor drum so that the electrostatic latent image is formed into a visualized image. At the transferring step, the visualized image on the surface of photoreceptor drum is transferred onto a recording medium such as paper or OHP sheet. At the fixing step, the visualized image is fixed-onto the recording medium by heat, pressure, etc. At the cleaning step, a toner and other matters remaining on the surface of photoreceptor drum from which the visualized image has been transferred, are removed by a cleaning blade, and the surface of photoreceptor drum is thus cleaned. Note that the visualized image may be transferred onto the recording medium by way of an intermediate transfer medium.

In the meantime, various techniques for computers have been further developed. For example, definition of computer images becomes higher and higher. This raises a demand on the electrophotographic image forming apparatus to form high-definition images almost equivalent to the computer images, which high-definition images reproduce tiny shapes, slight hue variation, etc. of the computer images precisely and clearly. In response to the demand, there has been an attempt to decrease a diameter of a toner, for example, and various studies have been made for manufacturing a toner whose particle diameter is around 5 μm that is effective for forming higher-definition images.

The small-diameter toner is useful for forming high-definition images. It is however difficult to stably form high-quality images by use of a toner which is merely decreased in particle diameter. The toner is thus required to have higher functions such as enhanced mixing property between a toner newly filled in a developer container and a toner existing in the developer container, in addition to basic properties such as charging property, developing property, transferring property, and fixing property.

In response to the demand as stated above, there has been proposed developer which has higher functions by defining a degree of circularity and surface roughness of a toner (refer to Japanese Unexamined Patent Publication JP-A 2005-274763, for example). The toner proposed in JP-A 2005-274763 is has an average degree of circularity of 0.975 or more, a median value of surface roughness distribution of 0.13 μm or more and less than 0.17 μm, a variation of arithmetic mean height of 20 or less, and a 90%-accumulation value of arithmetic mean height distribution of less than 0.30 μm. The average degree of circularity is determined in a manner that a circle-equivalent circumference length obtained from a projected area of toner particles is divided by a circumference length of a projection image of the toner particles. It can be stated that as the average degree of circularity is closer to a value 1, the projection image of toner particles is closer to a circle, that is to say, a shape of the toner is closer to a perfect sphere. The arithmetic mean height indicates surface roughness. The variation of arithmetic mean height indicates in percentage a standard deviation with reference to an average value of the arithmetic mean height. The toner as just described is used in form of two-component developer together with a carrier which has a median value of arithmetic mean height of 0.45 μm or more and 0.65 μm or less, a variation of arithmetic mean height of 30 or less, and a 90%-accumulation value of arithmetic mean height distribution of 0.9 μm or less.

As to the developer disclosed in JP-A 2005-274763, the toner and the carrier are provided with rough surfaces which make their mutual contact areas larger. The mixing property between the toner newly filled in the developer container and the toner existing in the developer container can be thus enhanced, which results in a faster rise of charging operation. Moreover, the toner has a shape of almost perfect sphere represented by 0.975 or more in the average degree of circularity, with the result that the developer is excellent in the transferring property.

The toner is however deteriorated in the cleaning property since the shape of the toner close to the perfect sphere represented by 0.975 or more in the average degree of circularity will cause the toner to be less easily caught by a cleaning blade when removing the toner remaining on the photoreceptor drum. In view of the foregoing, the small-diameter toner still needs to be improved, including enhancement of the cleaning property. A toner design is thus required which provides high-level charging start-up property and cleaning property and which is adaptable to formation of higher-definition images.

A shape design of carrier is also considered to be effective for enhancement in the charging start-up property of the toner in the case where the toner is used in form of two-component developer. Several techniques have been thus proposed concerning the shape design of carrier (refer to Japanese Unexamined Patent Publication JP-A 2004-53947, for example). A carrier proposed in JP-A 2004-53947 is composed of a carrier core material and a resin-coating layer formed thereon, and a weight average particle diameter of the carrier is 25 μm to 45 μm. In the carrier, carrier particles whose particle diameters are less than 22 μm occupy 7% by weight or less. An envelope coefficient of the carrier core material is less than 4.5. The envelope coefficient of the carrier core material is determined by multiplying 100 by a ratio of a difference to a length of envelope of projection image of the carrier core material, which difference is obtained by subtracting the length of envelope of projection image of the carrier core material from a length of periphery of the projection image of the carrier core material.

As to the carrier disclosed in JP-A 2004-53947, the envelope coefficient of the carrier core material is favorable, with the result that a carrier is not very bumpy and a thickness of the resin-coating layer is uniform. This allows the carrier to be inhibited from deteriorating over time and prevented from being attached to the photoreceptor.

The carrier disclosed in JP-A 2004-53947 is however unable to attain enhancement in the charging start-up property of the toner. Further, in the case of performing a shape design for the purpose of enhancing the charging start-up property of the toner, the shape design needs to be applied to also the toner which is used together with the carrier.

### SUMMARY OF THE INVENTION

An object of the invention is to provide a toner, a developer, and an image forming apparatus, which exhibit a quick rise of charging and excellent cleaning property and which can form high-quality images having high definition and high density.

The invention provides a toner which is formed of toner particles containing binder resin and a colorant, the toner satisfying the following formula (1):
2.0≦[(L1−L2)/L2]×100≦3.0 (1)
wherein L1 represents a circumference length of a projection image of the toner particles, and L2 represents a length of envelope of the projection image of the toner particles.

According to the invention, a relation is favorably set between a circumference length L1 of a projection image of toner particles containing binder resin and a colorant and a length L2 of envelope of the projection image of the toner particles. To be specific, a value determined by [(L1−L2)/L2]×100 is in a range of from 2.0 to 3.0. In the following description, the value determined by [(L1−L2)/L2]×100 will be referred to a toner envelope degree or an envelope degree of toner. A toner having a toner envelope degree of from 2.0 to 3.0 can swiftly come into contact at almost entire surfaces of toner particles with a regulating blade of a developing device and a carrier which is contained in developer in the case of using the toner in form of two-component developer. A rise of charging is therefore favorable after replenishment of the toner just stated. Accordingly, toner particles having a small charge amount are prevented from being generated even when a toner density of the developer is high. Furthermore, during a cleaning operation conducted by use of a cleaning unit, it is possible to prevent cleaning defects from appearing. Consequently, stable high-quality images exhibiting constant image densities can be formed without toner spattering or image fogs even in a color image for which a toner consumption is larger than that for a black-and-white image, or even in a high-humid environment where a charge amount tends to be small.

Further, in the invention, it is preferable that the toner particles exhibit an average degree of circularity of 0.980 or less.

According to the invention, an average degree of circularity of the toner particles is 0.980 or less and therefore, as compared to a perfectly spherical toner, for example, the toner particles are more easily caught by a cleaning blade and thus more easily removed by the blade, with the result that the cleaning property will be further enhanced.

Further, in the invention, it is preferable that the toner is an electrophotographic toner.

The invention provides a developer comprising the toner mentioned above and a carrier.

According to the invention, the electrophotographic developer is two-component electrophotographic developer which comprises the toner achieving the above effects and a carrier, with the result that an almost entire surface of the toner can come into contact with the carrier, thus exhibiting a favorable rise of charging after replenishment of the toner. This allows a quicker rise of charging and excellent cleaning property to appear, thus enabling formation of high-quality images having high definition and high density.

Further, in the invention, it is preferable that the following formula (2) is satisfied:
[(C1−C2)/C2]×100≦3.0 (2)
wherein C1 represents a circumference length of a projection image of the carrier, and C2 represents a length of envelope of the projection image of the carrier.

According to the invention, a relation is favorably set between a circumference length C1 of a projection image of the carrier and a length C2 of envelope of the projection image of the carrier. To be specific, a value determined by [(C1−C2)/C2]×100 is 3.0 or less. In the following description, the value determined by [(C1−C2)/C2]×100 will be referred to a carrier envelope degree. When the carrier envelope degree is 3.0 or less, a convex portion of the carrier can fit into a concave portion of the toner. Such a contact between the toner and the carrier at the concave portion of the toner can contribute to charging of the toner. This allows further enhancement in the charging property of the toner and a more favorable rise of charging after replenishment of the toner.

Further, in the invention, it is preferable that the developer is an electrophotographic developer.

The invention provide an image forming apparatus which uses the toner mentioned above to form an image.

According to the invention, an image forming apparatus which forms an image with the toner achieving the above effects, with the result that a rise of charging is quick and excellent cleaning property appears, thus enabling formation of high-quality images whose definition and density are high.

### BRIEF DESCRIPTION OF THE DRAWINGS

Other and further objects, features, and advantages of the invention will be more explicit from the following detailed description taken with reference to the drawings wherein:

FIG. 1 is a projection view schematically showing one example of shapes of toner particles contained in a toner of the invention;

FIG. 2 is a side view schematically showing a configuration of a chief part of a hot-air-type spheronizing device;

FIG. 3 is a sectional view of the chief part of the hot-air-type spheronizing device taken on line III-III of FIG. 2;

FIG. 4 is a sectional view schematically showing a configuration of an impact-type spheronizing device;

FIG. 5 is a perspective view showing a configuration of a classifying rotor disposed in the impact-type spheronizing device;

FIG. 6 is a sectional view schematically showing a configuration of an impact-type spheronizing device according to another embodiment; and

FIG. 7 is a view schematically showing a configuration of an image forming apparatus according to one embodiment of the invention.

### DETAILED DESCRIPTION

Now referring to the drawings, preferred embodiments of the invention are described below.

A toner of the invention is formed of toner particles which contain binder resin and a colorant. The toner is characterized in satisfying the following formula (1):
2.0≦[(L1−L2)/L2]×100≦3.0 (1)
wherein L1 represents a circumference length of a projection image of the toner particles, and L2 represents a length of envelope of the projection image of the toner particles.

Further, the toner of the invention is preferably an electrophotographic toner.

In the following description, a value determined by [(L1−L2)/L2]×100 will be referred to a toner envelope degree or an envelope degree of a toner. A toner having a toner envelope degree in a range of from 2.0 to 3.0 can swiftly come into contact at almost entire surfaces of toner particles with a regulating blade of a developing device and a carrier which is contained in developer in the case of using the toner in form of two-component developer. A rise of charging is therefore favorable after replenishment of the toner just stated. Accordingly, toner particles having a small charge amount are prevented from being generated even when a toner density of the developer is high. Furthermore, during a cleaning operation conducted by use of a cleaning unit, it is possible to prevent cleaning defects from appearing. Consequently, stable high-quality images exhibiting constant image densities can be formed without toner spattering or image fogs even in a color image for which a toner consumption is larger than that for a black-and-white image, or even in a high-humid environment where a charge amount tends to be small.

The toner envelope degree less than 2.0 will cause the toner particles to be less easily caught by the cleaning blade, with the result that the toner particles attached to the photoreceptor drum cannot be scraped off, thus leading to lower cleaning property. The toner envelope degree over 3.0 will cause the toner particles to be bumpier, which leads to a small contact area among the toner particles, a small contact area between the toner particles and the regulating blade, and a small contact area between the toner particles and the carrier, thus resulting in deterioration of the charging property of the toner. The toner particles having a small charge amount will be therefore generated, and problems such as toner spattering and image fogging will be caused. Moreover, it takes a long time until the charge amount of the toner reaches a favorable level, thus deteriorating the charging start-up property.

In the present specification, the circumference length L1 of the projection image of the toner particles and the length L2 of envelope of the projection image of the toner particles, which lengths L1 and L2 define the toner envelope degree, are determined in accordance with the following method.

Into a 100 ml beaker were put 2.0 g of a toner, 1 ml of alkylether sulfate ester sodium, and 50 ml of pure water, followed by well-stirring. Toner dispersion was thus fabricated. The toner dispersion was treated by an ultrasonic homogenizer (manufactured by Nippon Seiki Co., Ltd.) for five minutes at output of 50 μA so that the ingredients were further dispersed. The toner dispersion was then left at rest for six hours and supernatant solution thereof was removed, followed by addition of 50 ml of pure water and stirring through a magnetic stirrer for five minutes. A membrane filter (having an aperture diameter of 1 μm) was then used for suction filtration of a thus-obtained toner dispersion. A washed material obtained on the membrane filter was vacuum-dried in a silica gel-containing desiccator for about one night, resulting in an intended toner.

On thus-washed surfaces of the toner particles were formed metal films (that are Au films each having a thickness of 0.5 μm) by the sputtering deposition. From the metal film-coated toners, 200 to 300 toners were randomly extracted and photographed at accelerating voltage of 5 kV and at 1.000-fold magnification by a scanning electron microscope: S-570 (trade name) manufactured by Hitachi Ltd. Thus-obtained data of electron micrograph was image-analyzed by use of an image analysis software: A-zo kun (trade name) manufactured by Asahi Kasei Engineering Corporation. Parameters for analyzing particles, used in the image analysis software “A-zo kun”, were set as follows: small graphic-removed area was 100 pixels; the number of contraction and separation process was one; the number of graphics was one; no noise-cancelling filter was disposed; no shading compensation was carried out; and a unit for indicating a result was μm. Circumference lengths L1 of a projection image of toner particles and lengths L2 of envelope of the projection image of the toner particles were quantified, and average values thereof were respectively calculated, which were determined as the circumference length L1 of the projection image of toner particles and the length L2 of envelope of the projection image.

FIG. 1 a projection view schematically showing one example of shapes of toner particles 1 contained in a toner of the invention. A surface of the toner particle 1 includes a convex portion and a concave portion. For example, a convex portion 2 and a convex portion 3 form a concave portion 4, and in this case, a broken line 5 connecting a peak of the convex portion 2 and a peak of the convex portion 3 is an envelope.

Further, it is preferred that the toner of the invention have an average degree of circularity of toner particles of 0.980 or less. It is further preferred that the average degree of circularity of toner particles fall in a range of from 0.953 to 0.980. Toner particles having an average degree of circularity of 0.980 or less are, as compared to a perfectly spherical toner having a degree of circularity of 1.000, for example, more easily caught by a cleaning blade and thus more easily removed by the blade, resulting in further enhancement in the cleaning property. In the toner of the invention, the toner particles exhibit a toner envelope degree in the above preferable range and therefore, the toner particles are favorable in surface flatness even when the toner particles have irregular shapes. The toner of the invention is thus capable of exhibiting favorable charging start-up property and cleaning property.

Toner particles whose average degree of circularity exceeds 0.980, each have a shape close to a perfect sphere. Such toner particles are easily caught by the cleaning blade, which may lead to a decrease in the cleaning property. Toner particles whose average degree of circularity is less than 0.953, have irregular shapes. In this case, even when the toner envelope degree falls in the above range, a contact area between the toner particles and a photoreceptor drum and intermediate transfer medium is too large, thus leading to an increase in adhesion between the toner particles and the photoreceptor drum and intermediate transfer medium. As a result, a toner image formed on the photoreceptor drum or intermediate transfer medium is transferred onto a recording medium with lower transfer efficiency which may cause a formed image to contain a void or the like trouble. Accordingly, it is further preferred that the average degree of circularity of toner particles fall in a range of from 0.953 to 0.980.

A degree of circularity of toner particles (ai) herein is defined by the following formula (3). The degree of circularity (ai) as defined by the formula (3) is determined by using a flow particle image analyzer: FPIA-3000 manufactured by Sysmex Corporation. Moreover, an average degree of circularity (a) is defined by an arithmetic mean value which is obtained by a formula (4) that a sum of respective degrees of circularity (ai) of “m” pieces of toner particles is divided by the number of the toner particles, i.e., “m”.
Degree of circularity (ai)=(Circumference length of circle having the same projection area as that of particle image)/(Length of circumference of projection image of particles). (3)

$$Average degree of circularity ( a ) = {\sum }_{i = 1}^{m} ai / m \qquad ( 4 )$$

The above measurement system uses a simple method for estimation that the degrees of circularity (ai) of the respective toner particles are measured and then, a frequency is obtained in each of 61 divisions sectioned for every 0.01 from 0.40 to 1.00 in the obtained degrees of circularity (ai) of the respective toner particles, followed by calculation of the average degree of circularity using a center value and frequency in each of the divisions. An error between a value of the average degree of circularity obtained in the above simple method for estimation and a value of the average degree of circularity (a) given by the formula (4) is so small as to be ignorable in practice. The average degree of circularity obtained by the simple method for estimation is therefore regarded as the average degree of circularity (a) defined by the following formula (4) in the present embodiment.

A specific method of determining the average degree of circularity (ai) is as follows. Into 10 ml of water where an about 0.1 mg of surfactant is dissolved, 5 mg of the toner was dispersed, thus preparing dispersion. The dispersion was then irradiated for five minutes by ultrasonic wave with frequency of 20 kHz and output of 50 W. Using a concentration of toner particles in the dispersion, which is assumed as from 5,000 pieces/μl to 20,000 pieces/μl, the degree of circularity (ai) was determined by the above system “FPIA-3000”. The average degree of circularity (a) was thus obtained.

The toner of the invention contains binder resin, a colorant, and other components to be added to the toner. The other components to be added to the toner include, for example, a release agent and a charge control agent.

A selection of the binder resin is not particularly limited, and applicable is binder resin for black toner or color toner. Examples of the binder resin include: polyester-based resin; styrene-based resin such as polystyrene and styrene-acrylic ester copolymer resin; acryl-based resin such as polymethylmethacrylate; polyolefin-based rein such as polyethylene; polyurethane; and epoxy resin. It is also possible to use resin which is obtained by mixing a release agent into an admixture of raw material monomer to thereby effect polymerization reaction. The binder resin may be used each alone, or two or more of the binder resins may be used in combination. In forming the above binder resins, crystalline waxes or non-compatible substances may be finely dispersed in advance at synthetic stage. Among the above binder resins, particularly desirable is binder resin that contains as a main constituent polyester resin or polyether polyol resin which is excellent in thermal property such as resin elasticity.

The colorant includes, for example, colorants for yellow toner, colorants for magenta toner, colorants for cyan toner, and colorants for black toner.

Examples of the colorants for yellow toner include: disazo pigments such as C.I. pigment yellow 17; monoazo pigments such as C.I. pigment yellow 74 or C.I. pigment yellow 97; condensed azo pigments such as C.I. pigment yellow 93 or C.I. pigment yellow 128; and benzimidazolone pigments such as C.I. pigment yellow 180 or C.I. pigment yellow 194.

Examples of the colorants for magenta toner include: quinacridone pigments such as C.I. pigment red 122 or C.I. pigment red 202; lake azo pigments such as C.I. pigment red 57; perylene pigments such as C.I. pigment red 149, C.I. pigment red 190, or C.I. pigment red 224; and naphthol-benzimidazolone pigments such as C.I. pigment red 184 or C.I. pigment red 185.

Examples of the colorants for cyan toner include heretofore known phthalocyanine pigments and in particular, preferably used are C.I. pigment blue 15:3 and C.I. pigment blue 15:4.

Examples of the colorants for black toner include carbon black such as channel black, roller black, disc black, gas furnace black, oil furnace black, thermal black, and acetylene black. Among these various types of carbon black, suitable carbon black may be appropriately selected in accordance with the design characteristics of the intended toner.

Apart from those pigments, also usable herein are other red pigments and green pigments. The colorants may be used each alone, or two or more of the colorants may be used in combination. Further, two or more colorants of the same color type may be combined, or one or more colorants of one color type may be combined with those of a different color type.

The colorant is preferably used in form of master batch. The master batch of the colorant can be manufactured, for example, by kneading a molten material of synthetic resin and colorant. The usable synthetic resin is binder resin of the same sort as the binder resin in the toner, or resin which is well-compatible with the binder resin in the toner. A use ratio between the synthetic resin and the colorant is not limited to a particular ratio, and a preferable use ratio of the colorant is in a range of from 30 parts by weight to 100 parts by weight based on 100 parts by weight of the synthetic resin. Before used, the master batch has been granulated so as to have a particle diameter of around 2 mm to 3 mm, for example.

A content of the colorant in the toner of the invention is not particularly limited, and a preferable content thereof is in a range of from 4 parts by weight to 20 parts by weight based on 100 parts by weight of the binder resin. In the case of using the master batch, a usage of the master batch is preferably adjusted so that the content of the colorant in the toner of the invention falls in the above range. The use of the colorant in the above range allows formation of favorable images which are sufficient in image density and excellent in color development and image quality.

The toner of the invention may contain, other than the binder-resin and the colorant, components to be added to the toner, such as a release agent. When the release agent is contained in the toner, an anti-offset effect can be enhanced. The release agent includes, for example, petroleum wax such as paraffin wax and derivatives thereof, and microcrystalline wax and derivatives thereof; hydrocarbon-based synthetic wax such as Fischer-Tropsch wax and derivatives thereof, polyolefin wax and derivatives thereof, low-molecular polypropylene wax and derivatives thereof, and polyolefinic polymer wax and derivatives thereof; vegetable wax such as carnauba wax and derivatives thereof, rice wax and derivatives thereof, candelilla wax and derivatives thereof, and haze wax; animal wax such as bees wax and spermaceti wax; fat and oil-based synthetic wax such as fatty acid amides and phenolic fatty acid esters; long-chain carboxylic acids and derivatives thereof; long-chain alcohols and derivatives thereof; silicone polymers; and higher fatty acids. Examples of the derivatives include oxides, block copolymers of vinylic monomer and wax, and copolymers of vinylic monomer and wax. A usage of the release agent may be appropriately selected from a wide range without particular limitation, and preferably from 0.2 parts by weight to 20 parts by weight based on 100 parts by weight of the binder resin.

The toner of the invention may contain, other than the binder resin and the colorant, components to be added to the toner, such as a charge control agent. A frictional charge quantity of the toner can become favorable by the addition of the charge control agent. The usable charge control agent includes a charge control agent for positively charge control and a charge control agent for negatively charge control. The charge control agent for positively charge control includes, for example, a basic dye, quaternary ammonium salt, quaternary phosphonium salt, aminopyrine, a pyrimidine compound, a polynuclear polyamino compound, aminosilane, a nigrosine dye, a derivative thereof, a triphenylmethane derivative, guanidine salt, and amidine salt. The charge control agent for negatively charge control includes oil-soluble dyes such as oil black and spiron black, a metal-containing azo compound, an azo complex dye, metal salt naphthenate, salicylic acid, metal complex and metal salt (the metal includes chrome, zinc, and zirconium) of a salicylic acid derivative, a boron compound, a fatty acid soap, long-chain alkylcarboxylic acid salt, and a resin acid soap. One of the above charge control agents may be used each alone, and two or more of the above agents may be used in combination. A usage of the charge control agent may be appropriately selected from a wide range without particular limitation, and preferably from 0.5 part by weight or more and 3 parts by weight or less based on 100 parts by weight of the binder resin. Desirable charge control agents for use in a color toner are, for positively charge control, quaternary ammonium salt, and for negatively charge control, a colorless charge control agent represented by metal salt of alkyl salicylic acid.

The toner of the invention can be obtained, for example, by applying a spheronization process to a pulverized material of the resin composition containing the binder resin and the colorant. The resin composition containing the binder resin and the colorant can be obtained, for example, by melt-kneading a raw material containing the binder resin and the colorant.

At the melt-kneading step, for example, a raw material is firstly dry-mixed by a mixer. The raw material contains, for example, the binder resin and the colorant as stated above, and further contains the components which are added to the toner according to need, such as the release agent and the charge control agent. Such a raw material is then heated to a temperature which is equal to or higher than a softening temperature of the binder resin and less than a decomposition temperature of the binder resin, thereafter being melt-kneaded. The binder resin is thereby molten or softened so that ingredients in the toner raw material other than the binder resin are dispersed into the binder resin. Although the raw material containing the binder resin and the colorant does not have to be dry-mixed before melt-kneaded, the dry-mixing operation is preferably performed before the melt-kneading operation because the melt-kneading operation followed by the dry-mixing operation will enhance the dispersibility into the binder resin, of the ingredients such as the colorant other than the binder resin in the raw material so that a resultant toner can exhibit a uniform property such as the toner charging performance.

The mixers usable for the dry-mixing operation include, for example, Henschel-type mixing apparatuses such as a Henschel mixer (trade name) manufactured by Mitsui Mining Co., a super mixer (trade name) manufactured by Kawata Co., and a Mechanomill (trade name) manufactured by Okada Seiko Co., Ltd., Angmill (trade name) manufactured by Hosokawa Micron Co., Hybridization system (trade name) manufactured by Nara Machinery Co., Ltd., and Cosmo system (trade name) manufactured by Kawasaki Heavy Industry Co., Ltd.

For melt-kneading, it is possible to use kneading machines such as a kneader, a twin-screw extruder, a two roll mill, a three-roll mill, and laboplast mill. Specific examples of such kneading machines include single or twin screw extruders such as TEM-100B (trade name) manufactured by Toshiba Kikai Co., Ltd., PCM-65/87 and PCM-30, both of which are trade names and manufactured by Ikegai Co., and open roll-type kneading machines such as Kneadics (trade name) manufactured by Mitsui Mining Co. Among these kneading machines, the open roll-type kneading machines are particularly preferred. In the open roll-type kneading machines, a high shear kneading operation can be carried out at such a low temperature that viscosity of the resin does not decrease too much at the melting and therefore, the components added to the toner can be efficiently dispersed into the binder resin. The toner material may be melt-kneaded by using a plurality of the kneading machines. A melt-kneaded material obtained through the melt-kneading operation is then cooled-down to be solidified, resulting in a resin composition containing the binder resin and the colorant.

The resin composition obtained through the melt-kneading operation is pulverized by a hammer mill, a cutter mill, or the like machine, into a coarsely-pulverized material whose particle diameter is around 100 μm to 3 mm, for example. And then, such a coarsely-pulverized material is further pulverized into fine particles whose weight average particle diameter is 6.0 μm, for example. Machines usable for pulverizing the coarsely-pulverized material include, for example, a colliding airflow pulverizer using a jet stream, and a mechanical pulverizer.

The pulverized material of resin composition containing the binder resin and the colorant obtained as described above is treated with the spheronization process, thus resulting in the toner of the invention. The spheronization process includes a method using hot air, a method using mechanical impact force, or the like method so as to form the pulverized material of resin composition into a spherical shape. Hereinbelow, there will be described the method using hot air to form the pulverized material of resin composition into a spherical shape.

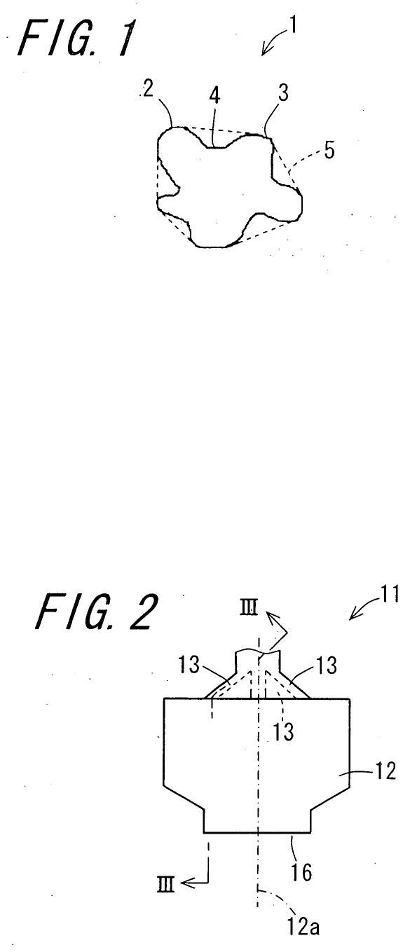

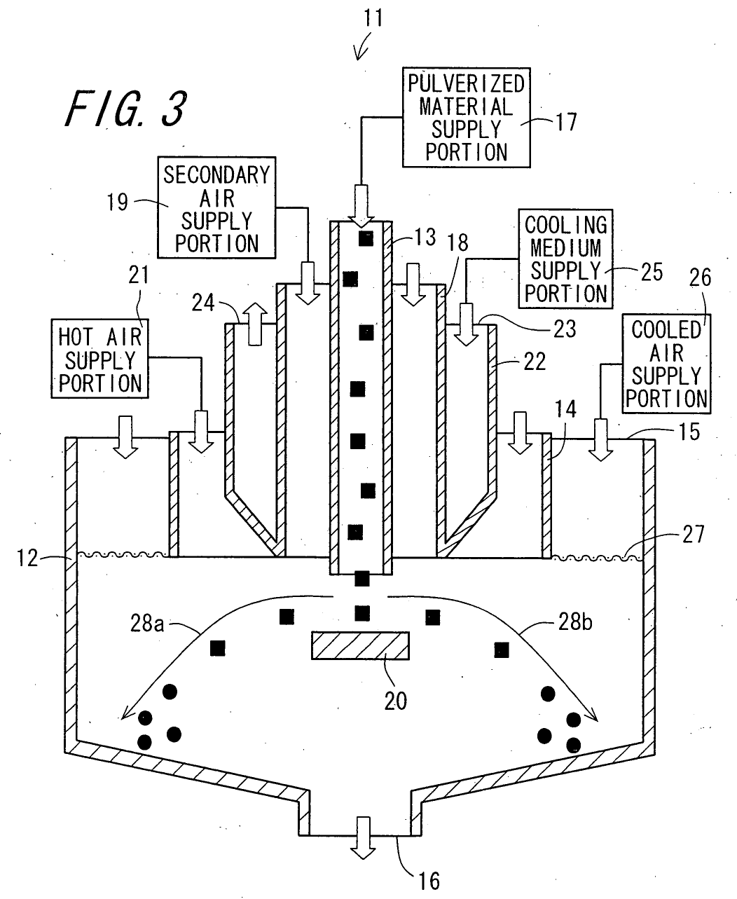

FIG. 2 is a side view schematically showing a configuration of a chief part of a hot-air-type spheronizing device 11. FIG. 3 is a sectional view of the chief part of the hot-air-type spheronizing device 11 taken on line III-III of FIG. 2. In FIG. 2, illustrations around a dispersing nozzle 13 are omitted except the dispersing nozzle 13. The hot-air-type spheronizing device 11 uses hot air to form the pulverized material of resin composition into a spherical shape. The hot-air-type spheronizing device 11 is composed of the dispersing nozzle 13, a hot-air injecting nozzle 14, and a cooled air inlet 15.

A treatment tank 12 is a substantially cylindrical treatment container which is tapered with a bottom surface at a lower position in an axial direction thereof being smaller in diameter. The treatment tank 12 is disposed so that the axial direction substantially corresponds to a vertical direction. The treatment tank 12 has on an upper part thereof the dispersing nozzle 13 and the hot-air injecting nozzle 14, and on an outer circumferential part of the treatment tank 12 is formed the cooled air inlet 15. Moreover, in the bottom surface of the treatment tank 12 is formed an outlet 16 for discharging the spherically-shaped pulverized material of resin composition.

The dispersing nozzle 13 is connected to a pulverized material supply portion 17 for supplying a fixed quantity of the pulverized material of the resin composition, and thereby injects the pulverized material of resin composition into the treatment tank 12 together with the air. Although only one dispersing nozzle 13 according to the present embodiment is shown in FIG. 3, four dispersing nozzles 13 are actually provided at regular intervals in a circumferential direction of the treatment tank 12. Those dispersing nozzles 13 inject the pulverized material in a direction which is inclined by 45° against the axial direction of the treatment tank 12 such that an injection port of the dispersing nozzle 13 is away from a shaft 12a of the treatment tank 12.

Around the dispersing nozzle 13 is disposed a secondary air injecting nozzle 18. The secondary air injecting nozzle 18 injects the air which is supplied by a secondary air supply portion 19 composed of a pump etc., toward a collision member 20 disposed inside the treatment tank 12. The air injected from the secondary air injecting nozzle 18 may be air which is not heated or cooled. The pulverized material injected from the pulverizing nozzle 13 is directed to the collision member 20 disposed inside the treatment tank 12 by the air injected from the secondary air injecting nozzle 18.

The collision member 20 disposed inside the treatment tank 12 is a dispersing board for dispersing through collision the pulverized material injected from the injecting nozzle 13. The collision member 20 may be, for example, a circular plate member. A shape of the collision member 20 is, however, not limited to the above-stated shape and may be, for example, a conical shape or circular truncated cone whose upper end is pointed, a conical shape whose upper and lower ends are both pointed, and the like shape.

The hot-air injecting nozzle 14 is provided around the dispersing nozzle 13 and the secondary air injecting nozzle 18. The hot-air injecting nozzle 14 is connected to a hot air supply portion 21 for supplying the air heated by a heating portion such as a heater, and thereby injects the hot air to the treatment tank 12. An admixture of the pulverized material of resin composition and the hot air flows in arrow 18a and 18b directions inside the treatment tank 12.

A temperature of the hot air injected by the hot-air injecting nozzle 14 is determined in accordance with a degree of circularity of intended toner particles. In the case of manufacturing the toner of the invention, the temperature of the hot air is preferably a temperature which is higher than a glass transition temperature of the binder resin by 120° C. to 160° C., that is, a temperature of the glass transition temperature of the binder resin+120° C. or higher and the glass transition temperature of the binder resin+160° C. or lower. The injection of the hot air having such a temperature can make the toner envelope degree be in a range of from 2.0 to 3.0.

When the temperature of the hot air injected by the hot-air injecting nozzle 14 is less than the glass transition temperature of the binder resin+120° C., surfaces of particles of the pulverized material are hard to be softened, which may result in a failure to reduce the envelope degree of the toner particles and thus may result in the toner envelope degree over 3.0. Further, when the temperature of the hot air injected by the hot-air injecting nozzle 14 exceeds the glass transition temperature of the binder resin+160° C., the binder resin and the like ingredients contained in the pulverized material may be softened by the hot air, thus resulting in aggregation of particles of the pulverized material. In addition, the toner envelope degree of particles of pulverized material may be less than 2.0.

On an outer circumference of the secondary air injecting nozzle 18 is provided a cooling jacket 22 for preventing the temperature of the dispersing nozzle 13 from rising up to a temperature equal to or higher than the softening temperature of the binder resin contained in the pulverized material of resin composition, which is caused by contact with the hot air flowing inside the hot-air injecting nozzle 14. The cooling jacket 22 has a cooling medium inlet 23 and a cooling medium outlet 24. The cooling medium inlet 23 is connected to a cooling medium supply portion 25. A cooling medium is supplied from the cooling medium supply portion 25 to the cooling jacket 22 via the cooling medium inlet 23, thereby cooling down the secondary air injecting nozzle 18 and the dispersing nozzle 13. The cooling medium used for the cooling then outflows from the cooling medium outlet 24. Specific examples of the cooling medium include water, air, and gas other than the air, which have been cooled down by a cooling device to a temperature equal to or lower than 10° C.

The cooled air inlet 15 is used to let the cooled air supplied by a cooled air supply portion 26 flow into the treatment tank 12. The cooled air inlet 15 is connected to the cooled air supply portion 26 so that the cooled air generated in the device is led into the treatment tank 12. The cooled air inlet 15 is provided with a filter 27.

The hot-air-type spheronizing device 11 having the configuration as described above forms the pulverized material of resin composition into the spherical shape as follows. First of all, the hot air is injected from the hot-air injecting nozzle 14 into the treatment tank 12 and at the same time, the cooling medium is made to flow inside the cooling jacket 22. Subsequently, solid-gas mixed fluid of the pulverized material of resin composition and the air is injected from the dispersing nozzle 13.

When the pulverized material of resin composition is injected from the dispersing nozzle 13, the pulverized material collides with the collision member 20. Since the pulverized material of resin composition is dispersed by the collision with the collision member 20 and the air injected from the secondary air injecting nozzle 18, the pulverized material of resin composition is supplied to the hot air in a state where the pulverized materials of resin composition are not in contact with each other. A temperature of the hot air is so high as the temperature which is higher than the glass transition temperature of the binder resin by 120° C. to 160° C. The surface of the pulverized material of resin composition is molten in such a high temperature region, thus resulting in spheronization of the pulverize material.

When the surface of the pulverized material of resin composition is molten to thereby result in spheronization of the pulverized material, the cooled air flows from the cooled air inlet 15 into the treatment tank 12. The pulverized material of resin composition which has been treated with the spheronization process is cooled down by the cooled air and thus solidified. Further, an inner wall of the treatment tank 12 is also cooled down by the cooled air inflowing from the cooled air inlet 15 and therefore, the pulverized material which has been treated with the spheronization process is not attached to the inner wall of the treatment tank 12 and thus discharged from the outlet 16 formed in a lower part of the treatment tank 12.

As described above, the pulverized material of resin composition is formed into the spherical shape. In the hot-air-type spheronizing device 11, the molten pulverized materials are prevented from coming into contact with each other and therefore, there is no difference between the average particle diameter of the pulverized material which has not yet been treated with the spheronization process and the average particle diameter of the pulverized material which has already been treated with the spheronization process. The spheronization process is thus performed without fusion of pulverized materials. The hot-air-type spheronizing device 11 as described above is used to form the pulverized material of resin composition into the spherical shape so that the toner envelope degree becomes 2.0 to 3.0. Further, it is preferred that the average degree of circularity of the toner particles be 0.980 or less. In the hot-air-type spheronizing device 11, the spheronization process can be carried out under conditions which are appropriately set so that the toner particle have such a shape as described above. The conditions for forming the toner particle having a diameter of from 2 μm to 5 μm into a favorable shape are, for example, a temperature and supply amount of the hot air, a temperature and supply amount of the cooled air, a position where the cooled air outlet 15 is formed, and the like element.

Further, the hot-air-type spheronizing device 11 has a very simple configuration and a compact size. Moreover, in the hot-air-type spheronizing device 11, the temperature rise of the inner wall of the treatment tank 12 is inhibited, thus resulting in a high product yield. Furthermore, the hot-air-type spheronizing device 11 having the configuration as described above is open-typed, which leads to almost no possibility of dust explosion and allows an immediate treatment with the hot air. As a result, the pulverized materials are not aggregated, and the entire pulverized material is uniformly treated.

For the hot-air-type spheronizing device 11 as described above, commercially-available devices are also usable including, for example, a surface-modifying machine: Meteo Rainbow (trade name) manufactured by Nippon Pneumatic MFG. Co., Ltd.

In the spheronization process conducted by the hot-air-type spheronizing device 11, there is no difference between the average particle diameter of the pulverized material which has not yet been treated with the spheronization process and the average particle diameter of the pulverized material which has already been treated with the spheronization process as described above, with the result that fine particle having a diameter less than 2 μm is contained. Accordingly, it is preferred that classification be carried out in order to remove the fine particles from the toner particles. The classification may be carried out before or after the spheronization process conducted by the hot-air-type spheronizing device 11.

The classification is preferably performed so that the weight average particle diameter of the entire toner particles is in a range of from 3 μm to 8 μm. When the weight average particle diameter of the entire toner particles is less than 3 μm, the particle diameter of the toner particle is too small, which may cause the toner to be highly charged and less fluidized. When the toner is highly charged and less fluidized, the toner cannot be stably supplied to the photoreceptor, which may cause a background fog and a decrease in image density. When the weight average particle diameter of the entire toner particles exceeds 8 μm, the particle diameter of the toner particle is too large to form high-resolution images. Further, the larger particle diameter of the toner particle decreases a specific surface area thereof, leading to a smaller charge amount of the toner. When the charge amount of the toner is small, the toner is not stably supplied to the photoreceptor, which may cause the toner spattering to result in contamination inside the apparatus.

Moreover, in forming the pulverized material of resin composition to the spherical shape, also applicable is, as described above, a method in which mechanical impact force is used to form the pulverized material of resin composition into the spherical shape. Hereinbelow, there will be described the method using mechanical impact force to form the pulverized material of resin composition into the spherical shape.

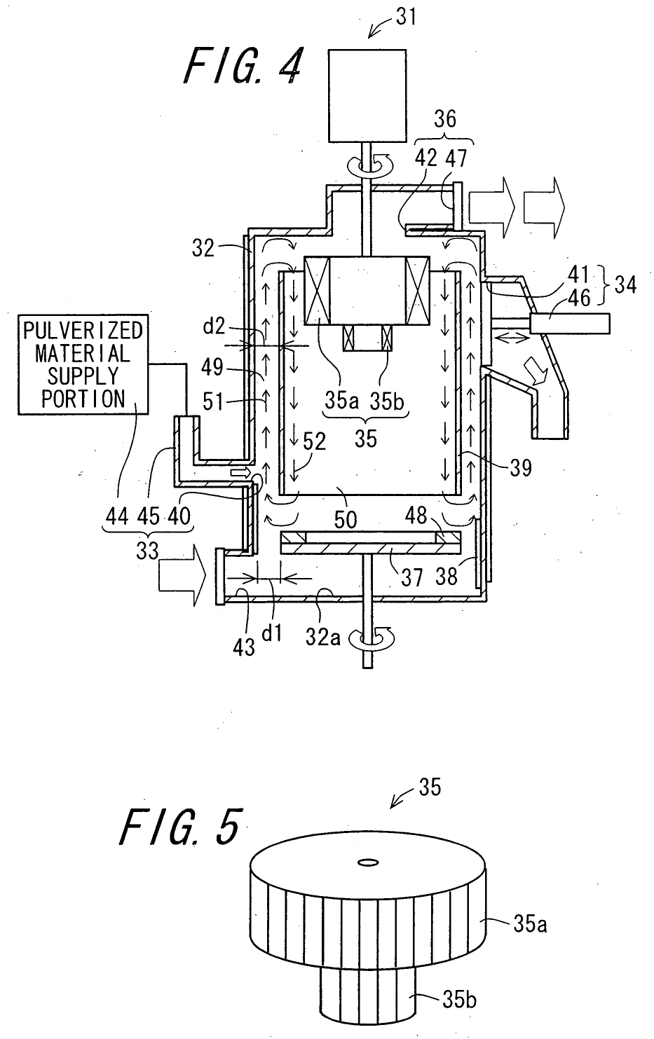

FIG. 4 is a sectional view schematically showing a configuration of an impact-type spheronizing device 31. FIG. 5 is a perspective view showing a configuration of a classifying rotor 35 disposed in the impact-type spheronizing device 31. The impact-type spheronizing device 31 uses the mechanical impact force to form the pulverized material of the resin composition into the spherical shape. The impact-type spheronizing device 31 includes a treatment tank 32, a pulverized material input portion 33, a toner particle discharge portion 34, a classifying rotor 35, a fine particle discharge portion 36, a dispersing rotor 37, a liner 38, and a partition member 39.

The treatment tank 32 is a substantially cylindrical container for treatment. Inside the treatment tank 32, the classifying rotor 35 is disposed in an upper part, and on side walls of the treatment tank 32 are formed a pulverized material inlet 40 of the pulverized material input portion 33 and a toner particle outlet 41 of the toner particle discharge portion 34. Further, a fine particle outlet 42 of the fine particle discharge portion 36 is formed on the side wall at an upper position from the classifying rotor 35 of the treatment tank 32. At a bottom part inside the treatment tank 32 are disposed the dispersing rotor 37 and the liner 38. Further, in the present embodiment, at a bottom surface portion 32a of the treatment tank 32 is formed a cooled air inlet 43 for letting the cooled air flow into the treatment tank 32. An internal diameter of the treatment tank 32 according to the embodiment is 20 cm.

The pulverized material input portion 33 includes a pulverized material supply portion 44, a pipeline 45, and a pulverized material inlet 40. The pulverized material supply portion 44 includes a storage container (not shown), a vibration feeder (not shown), and a compressed air intake nozzle (not shown). The storage container is a container-like member having an internal space where the pulverized material of resin composition is temporarily stored. Further, one end of the pipeline 45 is connected to one side surface or a bottom surface of the storage container, which communicates an internal space of the storage container and an internal space of the pipeline 45 with each other. The vibration feeder is disposed so that the storage container vibrates by vibration of the vibration feeder. The vibration feeder supplies the pulverized material of resin composition in the storage container into the pipeline 45. The compressed air intake nozzle is disposed so as to be connected to the pipeline 45 in the vicinity of a connection portion between the storage container and the pipeline 45. The compressed air intake nozzle supplies the compressed air into the pipeline 45 and accelerates the flow of the pulverized material of resin composition inside the pipeline 45 toward the pulverized material inlet 40. The pipeline 45 is a pipe-like member which has one end connected to the storage container and the other end connected to the pulverized material inlet 40. Through the pipeline 45, an admixture of the pulverized material of resin composition supplied from the storage container and the compressed air supplied from the compressed air intake nozzle is blown off from the pulverized material inlet 40 toward the inside of the treatment tank 32.

In the pulverized material supply portion 44 as stated above, the compressed air is firstly introduced from the compressed air intake nozzle into the pipeline 45 and at the same time, the pulverized material stored in the container of the supply portion is made to vibrate by the vibration feeder and thereby supplied from the storage container to the pipeline. The pulverized material supplied to the pipeline is delivered by pressure with the aid of the compressed air introduced from the compressed air intake nozzle, and then introduced into the treatment tank 32 from the pulverized material inlet 40 connected to a downstream side in an air intake direction of the pipeline 45.

The toner particle discharge portion 34 includes a toner particle discharge valve 46 and a toner particle outlet 41. The toner particle discharge portion 34 discharges to the outside of the treatment tank 32 the toner particles which are the pulverized material formed into the spherical shape inside the treatment tank 32. The toner particle discharge valve 46 is opened after a lapse of a predetermined treatment time. The opening of the toner particle discharge valve 46 causes the toner particles which are the pulverized material formed into the spherical shape inside the treatment tank 32, to be discharged from the toner particle outlet 41.

The classifying rotor 35 is a rotor for discharging fine particles each having a diameter less than 2 μm, for example, contained in the pulverized material which has been fed from the pulverized material input portion 33. The classifying rotor 35 classifies the pulverized materials in accordance with a particle diameter by utilizing the difference in centrifugal force given to the pulverized material depending on the weight of the pulverized material.

In the present embodiment, the classifying rotor 35 includes a first classifying rotor 35b and a second classifying rotor 35a. The first classifying rotor 35b is disposed below the second classifying rotor 35a and rotates in the same direction as that of the second classifying rotor 35a. Such an arrangement that the first classifying rotor 35b is disposed below the second classifying rotor 35a allows the pulverized material to be effectively dispersed even when the pulverized material has been aggregated, thus ensuring the removal of fine particles.

Above the classifying rotor 35 inside the treatment tank 32 is formed the fine particle outlet 42 through which the fine particles classified by the classifying rotor 35 are discharged. The fine particle discharge portion 36 includes the fine particle outlet 42 and a fine particle discharge valve 47 which is open during the spheronization process of the pulverized material.

In a lower part inside the treatment tank 32 are disposed a dispersing rotor 37 and a liner 38. The dispersing rotor 37 is composed of a circular plate member and a support shaft. The circular plate member is supported by the support shaft so that a circular surface of the circular plate member is parallel to a bottom surface of the treatment tank 32. An outer circumferential part in an upper surface in a vertical direction of the circular plate member is provided with a blade 48. The support shaft has one end connected to a lower surface in a vertical direction of the circular plate member and the other end connected to a driving mechanism (not shown). The support shaft supports the circular plate member and transfers to the circular plate member the rotary drive which is caused by the driving mechanism, in the same direction as that of the classifying rotor 35. This rotates the dispersing rotor 37 in the same direction as that of the classifying rotor 35. The liner 38 is a plate member which is provided at a position of an inner wall surface of the treatment tank 32, opposed to side surfaces of the circular plate member of the dispersing rotor 37 and the blade 48, so as to be fixed on the inner wall surface in contact therewith. In a surface of the liner 38 opposed to the side surfaces in the vertical direction of the circular plate member of the dispersing rotor 37 and the blade 48 is/are formed one groove or a plurality of grooves extending in substantially parallel with the vertical direction.

A clearance d1 between the dispersing rotor 37 and the liner 38 is in a range of from 1.0 mm to 3.0 mm. The clearance d1 in such a range allows an easy manufacture of the toner having the shape as above without increasing the burden on the device. When the clearance d1 between the dispersing rotor 37 and the liner 38 is less than 1.0 mm, the pulverized material will be further pulverized during the spheronization process, which may cause the pulverized material to be softened by heat. The pulverized material thus softened will cause the toner particles to be denatured and moreover, be attached to the dispersing rotor 37, the liner 38, and the other part, which increases the load on the device. This will result in a decrease in productivity of the toner. When the clearance d1 between the dispersing rotor 37 and the liner 38 exceeds 3.0 mm; a rotary speed of the dispersing rotor 37 needs to be higher in order to obtain toner particles having a high degree of circularity, which also causes the pulverized material to be further pulverized. Excessive pulverization of the pulverized material will cause the pulverized material to be softened, thus ending up with the same problem as mentioned above.

Above the dispersing rotor 37 inside the treatment tank 32 is disposed the partition member 39. The partition member 39 is a substantially cylindrical member for segmenting the inside of the treatment tank 32 into a first space 49 and a second space 50. A size of the partition member 39 is, when viewed in a radial direction thereof, smaller than a size of the dispersing rotor 37 and larger than a size of the classifying rotor 35. The first space 49 is a space located on a side of the inner wall surface inside the treatment tank 32 when viewed in a radial direction of the treatment tank 32. The second space 50 is a space located on an opposite side of the inner wall surface inside the treatment tank 32 when viewed in the radial direction of the treatment tank 32. The first space 49 is a space for leading to the classifying rotor 35 the pulverized material taken in and the pulverized material formed into the spherical shape. The second space 50 is a space for forming the pulverized material into the spherical shape with the aid of the dispersing rotor 37 and the liner 38.

A clearance d2 between one end of partition member 39 (hereinafter referred to as “an end of the partition member 39”) located on the side of the inner wall surface of the treatment tank 32 when viewed in the radial direction thereof, and the inner wall surface of the treatment tank 32 is preferably in a range of from 20.0 mm to 60.0 mm. When the clearance d2 between the end of the partition member 39 and the inner wall surface of the treatment tank 32 falls in such a range, the spheronization process can be efficiently carried out in a short time without increasing the burden on the device. When the clearance d2 between the end of the partition member 39 and the inner wall surface of the treatment tank 32 is less than 20.0 mm, an area of the second space 50 is too large and a residence time of the pulverized material circling in the second space 50 is short, which may result in insufficient spheronization of the pulverized material. This may cause a decrease in the productivity of the toner. When the clearance d2 between the end of the partition member 39 and the inner wall surface of the treatment tank 32 exceeds 60.0 mm, the residence time of the pulverized material around the dispersing rotor 37 is long and the pulverized material is further pulverized during the spheronization process, which may cause the surface of the pulverized material to be molten. This may lead to alteration of the surface of pulverized material and fusion of the pulverize material inside the device.

In the present embodiment, the bottom part of the treatment tank 32 below the dispersing rotor 37 when viewed in the vertical direction is provided with the cooled air inlet 43 for letting the cooled air flow into the treatment tank 32. The cooled air inlet 43 is used to let the air cooled down in a cooling process flow into the treatment tank 32. The cooled air inlet 43 is connected to the cooled air supply portion 26 so that the cooled air generated in the device is led into the treatment tank 32.

A temperature inside the treatment tank 32 rises up by collision of the pulverized material against the blade 48, the liner 38, the inner wall surface of the treatment tank 32, the partition member 39, etc. The cooled air inlet 43 helps the temperature inside the treatment tank 32 decrease by introducing the cooled air into the treatment tank 32. The temperature and inflow volume of the cooled air are not particularly limited and determined in accordance with the rotary speed of the dispersing rotor 37, the size of the treatment tank 32, and the like element so that the temperature inside the treatment tank 32 is equal to or less than the glass transition temperature of the binder resin contained in the resin composition, for example, from 20° C. to 40° C. A thermometer may be disposed inside the treatment tank 32 to measure the temperature inside the treatment tank 32. Alternatively, a temperature of the air discharged from the fine particle outlet 42 together with the fine particles may be measured to determine the temperature inside the treatment tank 32 since the temperature of the air substantially corresponds to the temperature inside the treatment tank 32. In the embodiment, the cooled air of from 0° C. to 20° C. is taken into the treatment tank 32. In this case, the temperature of the air discharged from the fine particle outlet 42 together with the fine particles is around 50° C.

The impact-type spheronizing device 31 having the configuration as described above forms the pulverized material of resin composition into the spherical shape as follows. First of all, the classifying rotor 35 and the dispersing rotor 37 are driven to rotate, and in a state where the fine particle discharge valve 47 is open, a predetermined amount of the pulverized material is put in the treatment tank 32 by the pulverized material input portion 33. The pulverized material is put in the first space 49 inside the treatment tank 32. An amount of the pulverized material fed by the pulverized material input portion 33 is determined in accordance with the processing ability of the device. The processing ability of the device is determined by the size of the treatment tank 32, the rotary speed of the dispersing rotor 37, and the like element. The pulverized material fed by the pulverized material input portion 33 circles in the first-space 49 by the rotation of the classifying rotor 35 and the dispersing rotor 37 and is directed to an upper part of the treatment tank 32 as illustrated by an arrow 51 until the pulverized material reaches the classifying rotor 35.

The pulverized material risen up to the classifying rotor 35 circles by the rotation of the classifying rotor 35, and the centrifugal force is thus imparted to the pulverized material. The pulverized material having a small weight passes through the classifying rotor 35 and then discharged from the fine particle discharge outlet 42 since the centrifugal force acted on the pulverized material having a small weight is smaller than the centrifugal force acted on the pulverized material having a large weight. The pulverized material which has not discharged from the fine particle outlet 42, circles in the second space 50 and is thus directed downward in an arrow 52 direction. When the pulverized material reaches the dispersing rotor 37, the pulverized material is formed into the spherical shape by collision against the blade 48 of the dispersing rotor 37, collision against the liner 38, and the like action, thereafter moving back to the first space 49.

The pulverized material moved to the first space 49 rises again up to the classifying rotor 35, and the pulverized material having a small weight is discharged from the fine particle outlet 42. The pulverized material which is not discharged from the fine particle outlet 42, circles again in the second space 50 and is directed downward to the dispersing rotor 37 to be thereby formed into the spherical shape.

The process just described is repeated, and after a lapse of a predetermined time, the toner particle discharge valve 46 of the toner particle discharge portion 34 is opened. When the toner particle discharge valve 46 is opened, the pulverized material present in the first space 49 is discharged from the toner particle outlet 41. The pulverized material thus discharged from the toner particle outlet 41 is formed of particles which have been treated with the spheronization process. Such particles will become toner particles. As described above, the pulverized material can be formed into the spherical shape.

A length of time for the spheronization process is not particularly limited, and preferably from 5 to 240 seconds and more preferably from 30 to 24.0 seconds. When the length of time for the spheronization process is from 5 to 240 seconds, it is easy to obtain the toner of the invention as described above. When the length of time for the spheronization process is from 30 to 240 seconds, the entire pulverized material can be uniformly formed into the spherical shape and moreover, the fine particles can be reliably removed. It is therefore more preferable to set the time for the spheronization process in such a range.

When the length of time for the spheronization process is less than 5 seconds, the envelope degree of the pulverized material cannot be small, which may result in a failure to obtain the toner of the invention having the shape as described above. When the length of time for the spheronization process exceeds 240 seconds, the length of time for the spheronization process is too long, and the surfaces of the toner particles are easily denatured by heat generated by the spheronization process, which may cause the pulverized material to be fused inside the device. This leads to a decrease in the productivity of the toner particles.

In the impact-type spheronizing device 31 as described above, the fine particles are removed by the classifying rotor 35 and there is therefore no need to provide a separate classifying step. From such a viewpoint, the impact-type spheronizing device 31 is preferred.

For the impact-type spheronizing device 31 as described above, commercially-available devices are also usable including, for example, Faculty (trade name) manufactured by Hosokawa Micron Corporation.

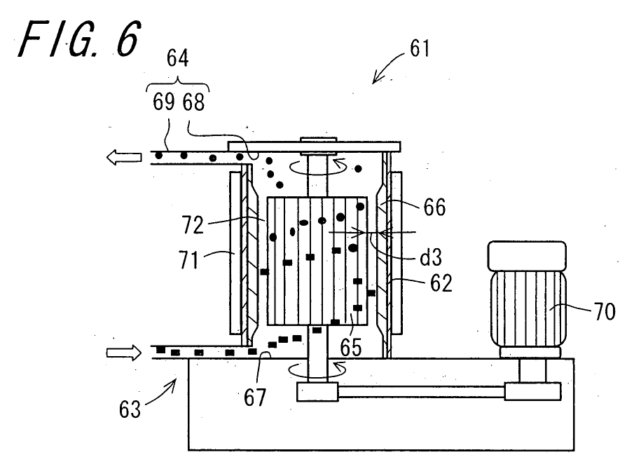

FIG. 6 is a sectional view schematically showing a configuration of an impact-type spheronizing device 61 according to another embodiment. The impact-type spheronizing device 61 uses the mechanical impact force to form the pulverized material of the resin composition into the spherical shape. The impact-type spheronizing device 61 includes a treatment tank 62, a pulverized material input portion 63, a toner particle discharge portion 64, a dispersing rotor 65, and a stator 66.

The treatment tank 62 is a substantially cylindrical container for treatment. Inside the treatment tank 62, the dispersing rotor 65 and the stator 66 are provided. In a lower part of the treatment tank 62 is formed a pulverized material inlet 67 of the pulverized material input portion 63. Further, in an upper part of the treatment tank 62 is formed a toner particle outlet 68 of the toner particle discharge portion 64. An inner diameter of the treatment tank 62 according to the present embodiment is 20 cm.

The pulverized material input portion 63 has the same configuration as that of the pulverized material input portion 33 provided in the above-described impact-type spheronizing device 31, and a description of the pulverized material input portion 63 will be therefore omitted. The toner particle discharge portion 64 includes the tone particle outlet 68 and a toner particle discharge pipe 69. The toner particle discharge portion 64 discharges the toner particles which are the pulverized material formed into the spherical shape inside the treatment tank 62, to the outside of the treatment tank 62 via the tone particle outlet 68 and the toner particle discharge pipe 69.

Inside the treatment tank 62 are provided the dispersing rotor 65 and the stator 66. The dispersing rotor 65 is configured so as to be rotatable by a motor 70. The dispersing rotor 65 rotates around an axial line which corresponds to an axial line of the treatment tank 62, inside the treatment tank 62. The stator 66 is disposed in contact with an inner wall surface of the treatment tank 62.

A clearance d3 between the dispersing rotor 65 and the stator 66 is from 1.0 mm to 6.0 mm. When the clearance d3 between the dispersing rotor 65 and the stator 66 falls in such a range, the toner having the shape as above can be easily manufactured without increasing the burden on the device. When the clearance d3 between the dispersing rotor 65 and stator 66 is less than 1.0 mm, the pulverized material will be further pulverized during the spheronization process, which may cause the pulverized material to be softened by heat. The pulverized material thus softened will cause the toner particles to be denatured and moreover, be attached to the dispersing rotor 65, the stator 66, and the other part, which increases the load on the device. This will result in a decrease in productivity of the toner. When the clearance d3 between the dispersing rotor 65 and the stator 66 exceeds 6.0 mm, it is difficult to generate high-speed airflow inside the treatment tank 62, and the pulverized material of resin composition cannot be formed into the spherical shape sufficiently.

It is preferred that the clearance d3 between the dispersing rotor 65 and the stator 66 be set at from 3.0 mm to 5.0 mm. By setting the clearance d3 in such a range, it becomes easier to obtain the toner particles of which toner envelope degree falls in a range of from 2.0 to 3.0.

Further, an outer wall surface of the treatment tank 62 is provided with a cooling jacket 71. A temperature inside the treatment tank 62 rises up by collision of the pulverized material against the dispersing rotor 65, the stator 66, etc. The cooling jacket 71 cools the outer wall surface of the treatment tank 62 and thereby decreases the temperature inside the treatment tank 62. The cooling jacket 71 cools the outer wall surface of the treatment tank 62 so that the temperature inside the treatment tank 62 is equal to or less than the glass transition temperature of the binder resin contained in the resin composition, for example, from 20° C. to 40° C.

The impact-type spheronizing device 61 having the configuration as described above forms the pulverized material of resin composition into the spherical shape as follows. First of all, in a state where the dispersing rotor 65 is rotatable by the motor 70, the pulverized material is fed from the pulverized material input portion 63 into the treatment tank 62. The pulverized material is put in a treatment space 72 between the dispersing rotor 65 and the stator 66 inside the treatment tank 62. An amount of the pulverized material fed by the pulverized material input portion 63 is determined in accordance with the processing ability of the device. The processing ability of the device is determined by the size of the treatment tank 62, the rotary speed of the dispersing rotor 65, and the like element. The pulverized material fed by the pulverized material input portion 63 circles in the treatment space 72 by the rotation of the dispersing rotor 65 as the pulverized material collides with the dispersing rotor 65, the stator 66, and the other particles of pulverized material, and is thus directed to an upper part of the treatment tank 62. Such collisions against the dispersing rotor 65, the stator 66, and the other particles of pulverized material contribute to the spheronization of the pulverized material. The pulverized material risen up to the upper part of the treatment tank 62 is discharged from the toner particle discharge portion 64. As described above, the pulverized material can be formed into the spherical shape.

The impact-type spheronizing device 61 as described above has no classifying rotor. Accordingly, it is preferred that classification be carried out in order to remove the fine particles from the toner particles. The classification may be carried out before or after the spheronization process conducted by the impact-type spheronizing device 61.

For the impact-type spheronizing device 61 as described above, commercially-available devices are also usable including, for example, Kryptron (trade name) manufactured by Earth Technica Co., Ltd.

Further, the toner of the invention only needs to have the toner particles of which toner envelope-degree falls in a range of from 2.0 to 3.0. Accordingly, the toner of the invention is not limited to the toner which is obtained by the spheronization of the pulverized material of resin composition fabricated through the melt-kneading pulverizing method. The toner of the invention can be obtained also through a so-called polymerization method such as a suspension method, an emulsion aggregation method, or a drying-in-liquid method, in each of which method particles are produced in an aqueous solution or solvent.

With the toner particles manufactured as described above, an external additive may be mixed which bears the functions of, for example, enhancement in particle flowability, enhancement in a frictional charging property, heat resistance, improvement in long-term conservation, improvement in a cleaning property, and a control on wear characteristics of photoreceptor surfaces. Examples of the external additive include fine particles of silica, fine particles of titanium oxide, and fine particles of alumina. These inorganic fine particles are preferably treated with a treatment agent for the purpose of hydrophobizing and control on the charging property when necessary. Examples of the treatment agent include silicone varnish, denatured silicone varnish of various types, silicone oil, denatured silicone oil of various types, a silane coupling agent, a silane coupling agent having a functional group, and the other organic silicon compound. Two or more of the treatment agents may be used in combination. The external additives may be used each alone, or two or more of the external additives may be used in combination. An additive amount of the external additive is preferably 2 parts by weight or less based on 100 parts by weight of the toner particles in consideration of a charge amount necessary for the toner, influence on a photoreceptor wear caused by addition of the external additive, environmental characteristics of the toner, and the like element.

Moreover, as the other additives, lubricant may be used including, for example, fluorine resin, zinc stearate, polyvinylidene-fluoride, and (about 40%-silica containing) particles of silicone oil. Further, white fine particles having a reverse polarity to that of the toner particles may also be used in small amount as a developing property enhancer.

The toner formed of toner particles to which the external additive has been added according to need as described above, can be directly used in form of one-component electrophotographic developer. It is however preferred that the toner of the invention be mixed with a carrier and thus used in form of two-component developer. Further, the developer is preferably electrophotographic developer. The two-component developer containing the toner of the invention exhibits a toner envelope degree in a range of from 2.0 to 3.0 and therefore, an almost entire surface of the toner can come into contact with the carrier, thus exhibiting a favorable rise of charging after replenishment of the toner. This allows a quicker rise of charging and excellent cleaning property to appear, thus enabling formation of high-quality images having high definition and high density.

As the carrier, magnetic particles can be used. Specific examples of the magnetic particles include metals such as iron, ferrite, and magnetite; and alloys composed of the metals just cited and metals such as aluminum or lead. Among these examples, ferrite is preferred.

Further, the carrier can be a resin-coated carrier in which the magnetic particles are coated with resin, or a dispersed-in-resin carrier in which the magnetic particles are dispersed in resin. The resin for coating the magnetic particles includes, without particular limitation, olefin-based resin, styrene-based resin, styrene-based/acrylic resin, silicone-based resin, ester-based resin, and fluorine-containing polymer-based resin, for example. The resin used for the dispersed-in-resin carrier includes, also without particular limitation, styrene acrylic resin, polyester resin, fluorine-based resin, and phenol resin, for example.

It is preferred that the carrier mixed with the toner of the invention satisfy the following formula (5):
[(C1−C2)/C2]×100≦3.0 (5)
wherein C1 represents a circumference length of a projection image of the carrier, and C2 represents a length of envelope of the projection image of the carrier.

In the following description, the value determined by [(C1−C2)/C2]×100 will be referred to a carrier envelope degree. When the carrier envelope degree is 3.0 or less, a convex portion of the carrier can fit into a concave portion of the toner, which means that the toner and the carrier can be in contact with each other even at the concave portion of the toner. This can shorten a length of time required for charging the toner particles up to a favorable charge amount. This allows further enhancement in the charging property of the toner and further enhancement in the charging start-up property after replenishment of the toner. When the carrier envelope degree exceeds 3.0, the carrier is bumpier, which may cause the toner to be buried in the concave portion of the carrier and thus cause the toner to be inhomogeneously charged.

Further, it is further preferred that the carrier envelope degree of the carrier mixed with the toner of the invention fall in a range of from 2.0 to 3.0. That is to say, the circumference length C1 of the projection image of the carrier and the length C2 of envelope of the projection image of the carrier preferably satisfy the following formula (6):
2.0≦[(C1−C2)/C2]×100≦3.0 (6)

When the carrier envelope degree is less than 2.0, the surface of the carrier is less bumpy and thus flat and smooth, with the result that the contact area between the carrier and the toner is too small, which may cause a difficulty in imparting charges to the toner.

The circumference length C1 of the projection image of the carrier and the length C2 of envelope of the projection image of the carrier, both of which length are used to determine the carrier envelope degree, can be obtained in the same manner as the above-described case of obtaining the circumference length L1 of the projection image of toner particles and the length L2 of envelope of the projection image of the toner particles, both of which length are used to determine the toner envelope degree. To be specific, 200 to 300 carriers are randomly extracted and photographed at accelerating voltage of 5 kV and at 1.000-fold magnification by a scanning electron microscope: S-570 (trade name) manufactured by Hitachi Ltd. Thus-obtained data of electron micrograph is image-analyzed by use of an image analysis software: A-zo kun (trade name) manufactured by Asahi Kasei Engineering Corporation, and an average value of thus-obtained values is then calculated.

A particle diameter of the carrier is not particularly limited and in consideration of formation of higher-quality images, a preferable particle diameter of the carrier is 30 μm to 50 μm. Furthermore, a resistivity of the carrier is preferably 10⁸Ω·cm or more and more preferably 10¹²Ω·cm or more. The resistivity of the carrier is determined in a manner that the carrier is put in a container having a sectional area of 0.50 cm followed by tapping, and a load of 1 kg/cm² is then applied to the particles put in the container, thereafter reading a current value upon application of voltage which generates an electric field of 1,000 V/cm between the load and a bottom electrode. When the resistivity is small, application of bias voltage to a developing sleeve will cause charges to be injected to the carrier, which makes the carrier particles be easily attached to the photoreceptor. Further, in this case, breakdown of the bias voltage occurs more easily.

A magnetization intensity (maximum magnetization) of the carrier is preferably from 10 emu/g to 60 emu/g, and more preferably from 15 emu/g to 40 emu/g. The magnetization intensity depends on magnetic flux density of a developing roller. Under a condition that the developing roller has normal magnetic flux density, the magnetization intensity less than 10 emu/g will lead to a failure to exercise magnetic binding force, which may cause the carrier to be spattered. When the magnetization intensity exceeds 60 emu/g, it becomes difficult to keep a noncontact state with an image bearing member in a noncontact phenomenon where brush of the carrier is too high, and in a contact phenomenon, sweeping patterns may appear more frequently in a toner image.

A use ratio between the toner and the carrier contained in the two-component developer may be appropriately selected according to kinds of the toner and carrier without particular limitation. To take the case of the resin-coated carrier (having density of from 5 g/cm² to 8 g/cm²) as an example, it is only required that the use amount of the toner contained in the developer is from 2% by weight to 30% by weight and preferably from 2% by weight to 20% by weight based on a total amount of the developer. In the two-component developer, a preferable coverage of the toner over the carrier is from 40% to 80%.

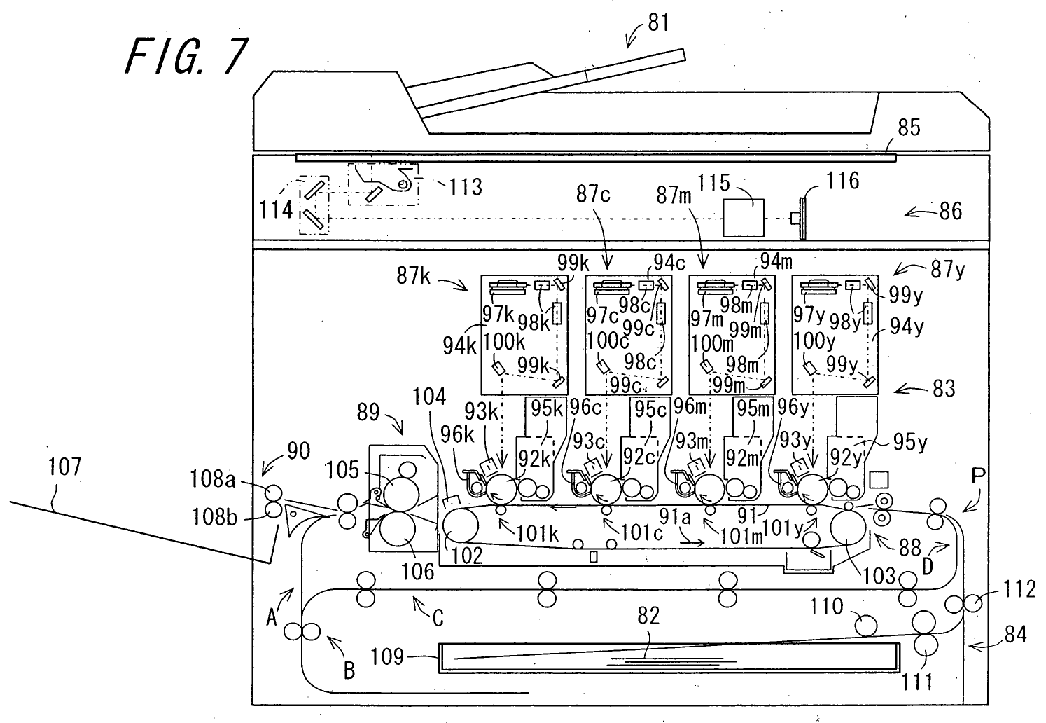

FIG. 7 is a view schematically showing a configuration of an image forming apparatus 81 according to one embodiment of the invention. In the image forming apparatus 81, the toner of the invention is used to form images. Materials such as a colorant are appropriately selected for use in the toner of the invention. The toner of the invention is thus used in form of a cyan toner, a magenta toner, an yellow toner, and a black toner.

The image forming apparatus 81 includes an image forming section 83 for forming an image on a recording medium 82, a paper feeding section 84 for supplying the recording medium 82 to the image forming section 83, and an image reading section 86 for reading an image on a document disposed on a document table 85.

The image forming section 83 includes image forming units 87y, 87m, 87c, and 87k, a transferring unit 88, a fixing unit 89, and a paper discharging unit 90.

The image forming units 87y, 87m, 87c, and 87k are arranged in a line in the order just stated from an upstream side in a sub-operation direction which is a direction that a recording medium bearing member, i.e., a conveying belt 91 moves (rotates), that is, in an arrow 91a direction. In the image forming units 87y, 87m, 87c, and 87k, electrostatic latent images corresponding to image information of respective hues are formed on respective surface portions of photoreceptors 92y, 92m, 92c, and 92k which serve as image bearing members, and the electrostatic latent images are developed to thus form toner images of respective colors. Accordingly, the image forming unit 87y forms a toner image which corresponds to image information of yellow color. The image forming unit 87m forms a toner image which corresponds to image information of magenta color. The image forming unit 87c forms a toner image which corresponds to image information of cyan color. The image forming unit 87k forms a toner image which corresponds to image information of black color.

The image forming unit 87y includes the photoreceptor 92y, a charging portion 93y, an exposing unit 94y, a developing portion 95y, and a cleaning portion 96y.

The photoreceptor 92y is a roller-shaped member which can rotate about a shaft center thereof by a rotary drive mechanism (not shown) and on which surface portion an electrostatic latent image is formed. The rotary drive mechanism of the photoreceptor 92y is controlled by a control portion realized by CPU (central processing unit). The photoreceptor 92y is composed of, for example, a cylindrical or columnar conductive substrate (not shown) and a photosensitive layer (not shown) formed on a surface portion of the conductive substrate. For the conductive substrate, an aluminum bare tube can be used, for example. The photosensitive layer may be a laminate composed of a charge-generating layer containing a charge-generating substance and a charge-transporting layer containing a charge-transporting substance. Alternatively, the photosensitive layer may contain the charge-generating substance and the charge-transporting substance in one layer. An undercoat layer may be provided between the photosensitive layer and the conductive substrate. Furthermore, a protective layer may also be provided on the surface portion of the photosensitive layer.

The charging portion 93y charges the surface portion of the photoreceptor 92y so that the surface portion has predetermined potential of a predetermined polarity. In the present embodiment, a non-contact corona charger is used for the charging portion 93y. Note that the charging portion 93y is not limited to the non-contact corona charger and may also be any other contact-type charger such as a charging roller or a charging brush. In the embodiment, the charging portion 93y charges the surface portion of the photoreceptor 92y at −600 V.

The exposing unit 94y is a device which emits signal light (laser light) corresponding to image information of yellow color to the charged surface portion of the photoreceptor 92y and thereby forms an electrostatic latent image corresponding to the image information of yellow color. The exposing unit 94y includes a semiconductor laser element (not shown), a polygon mirror 97y, an fθ lens 98y, and mirrors 99y and 100y. The semiconductor laser element receives from the later-described image reading section 86 pixel signal corresponding to the image information of yellow color of an original document disposed on the document table 85, and emits the laser light which is dot light modulated according to the pixel signal. The polygon mirror 97y deflects the laser light emitted from the semiconductor laser element in a main scanning direction. The fθ lens 98y and a plurality of mirrors 99y and 100y are used to lead the deflected laser light onto the surface portion of the photoreceptor 92y where an image is thus provided. In the embodiment, the exposing unit 94y forms on the surface portion of the photoreceptor 92y an electrostatic latent image corresponding to the image information of yellow color at an exposure potential of −70V.

The developing portion 95y is provided opposite to and away from the surface portion of the photoreceptor 92y so that a gap is formed between the developing portion 95y and the photoreceptor 92y. The developing portion 95y supplies the yellow toner to the electrostatic latent image which corresponds to the image information of yellow color, formed on the surface portion of the photoreceptor 92y, and thus transforms the electrostatic latent image to an yellow toner image. The developing portion 95y includes a developing roller, a stirring roller, a development tank, and a container for toner replenishment, all of which are not shown. The developing roller is a roller-shaped member which is disposed away from the surface portion of the photoreceptor 92y through an opening of the development tank so that a tiny gap is formed between the developing roller and the surface portion of the photoreceptor 92y and which is supported by the development tank so as to be rotatable in a counterclockwise direction when viewed on the sheet of FIG. 7 and moreover which contains a fixed magnetic pole. The developing roller supplies the yellow toner to the electrostatic latent image on the surface portion of the photoreceptor 92y. To the developing roller is applied the developing bias having the same polarity as that of the toner, that is, the negative polarity, by a developing bias applying section (not shown). In the embodiment, as the developing bias, direct voltage of −240 V is applied to the developing roller. The stirring roller is a roller-shaped member which is disposed inside the development tank so as to be rotatable about a shaft center of the stirring roller. The stirring roller supplies the yellow toner to a surface portion of the developing roller. The development tank houses the developing roller and the stirring roller, and stores the two-component developer of the invention containing the yellow toner and the magnetic carrier which exhibit the predetermined particle size distribution. The container for toner replenishment is disposed in contact with an upper part of the development tank when viewed in the vertical direction, and communicates with the development tank through a hole for toner replenishment (not shown) which is a through hole.

In the embodiment, the yellow toner contained in the development tank is negatively charged when stirred with the stirring roller and rubbed with the magnetic carrier, and then is supplied to the developing roller. The yellow toner contained in the development tank is charged by the stirring operation of the stirring roller and then supplied to the surface portion of the developing roller, thereafter being supplied to the electrostatic latent image on the surface portion of the photoreceptor 92y with the aid of, for example, a difference in potential between the photoreceptor 92y and the developing roller, and thus forming the toner image corresponding to the image information of yellow color.

The cleaning portion 96y operates as follows. After the yellow toner image formed on the surface portion of the photoreceptor 92y has been transferred onto the recording medium 82 carried on the later described conveying belt 91, the cleaning portion 96y removes and collects the yellow toner still remaining on the surface portion of the photoreceptor 92y. In the color toner according to the embodiment, a charge amount of the toner of each color falls in a predetermined set range and therefore, the adhesions between the photoreceptors and the toners of respective colors are equal to each other. Accordingly, the cleaning portions each having the same structure can be used for respective colors. The cleaning portion 96y may have a simple structure including, for example, a cleaning blade provided in contact with the surface portion of the photoreceptor, and a waste toner container for storing the waste toner removed by the cleaning blade from the surface portion of the photoreceptor. Accordingly, the inside stricture of the image forming apparatus 81 may be simplified, and the production cost of the apparatus can be reduced.

In the image forming unit 87y, the surface portion of the photoreceptor 92y is charged by the charging portion 93y while the photoreceptor 92y is driven to rotate about a shaft center thereof, and then the charged surface portion of the photoreceptor 92y is irradiated with signal light corresponding to the image information of yellow color, which signal light is emitted from the exposing unit 94y, whereby an electrostatic image corresponding to the image information of yellow color is formed, and the yellow toner is then supplied by the developing portion 95y to the electrostatic latent image to thereby form an yellow toner image. The yellow toner image is transferred onto the recording medium 82 carried by the conveying belt 91 which runs in the arrow 91a direction in pressure-contact with the surface portion of the photoreceptor 92y as described below. The yellow toner which still remains on the surface portion of the photoreceptor 92y after the toner image has been transferred, is removed and collected by the cleaning portion 96y.

The image forming units 87m, 87c and 87k each have a structure similar to that of the image forming unit 87y except that they each use developer containing a magenta toner, a cyan toner, or a black toner. Accordingly, the same reference numerals are given to components in the structure, which numerals are respectively terminated with “m” indicating magenta, “c” indicating cyan, or “k” indicating black, and descriptions thereof will be omitted.

The transferring unit 88 includes the conveying belt 91, transferring rollers 101y, 101m, 101c, and 101k, a driving roller 102, a driven roller 103, and a charge-removing portion 104.

The conveying belt 91 is an endless belt member which can rotate in the sub-operation direction, that is, the arrow 91a direction, and is disposed in pressure-contact with, in the order cited as follows, the image bearing members, i.e., the photoreceptors 92y, 92m, 92c, and 92k, and which is stretched out on the driving roller 102 and the driven roller 103 to thereby form a loop-like travel path. The conveying belt 91 is a recording medium bearing member for carrying and thus conveying the recording medium 82. The positions at which the conveying belt 91 is in pressure-contact with the photoreceptors 92y, 92m, 92c, and 92k, are transfer positions at which the toner images of respective colors are transferred. The conveying belt 91 carries and thus conveys the recording medium 82 supplied by the later-described paper feeding section 84. Onto the recording medium 82 are transferred the toner images of respective colors so that the toner images are combined with each other, at the transfer positions where the recording medium 82 comes to contact with the photoreceptors 92y, 92m, 92c, and 92k. A multicolor toner image is thus formed.

The transferring rollers 101y, 101m, 101c, and 101k are roller-shaped members which are provided respectively in pressure-contact with the photoreceptors 92y, 92m, 92c, and 92k via the transferring belt 91 and which can rotate about their own shaft centers by a driving mechanism (not shown). The positions at which the transferring rollers 101y, 101m, 101c, and 101k come to pressure-contact with the photoreceptors 92y, 92m, 92c, and 92k, are transfer positions at which the toner images of respective colors are transferred onto the recording medium 82 carried by the conveying belt 91. To the transferring rollers 101y, 101m, 101c, and 101k are applied the transfer bias having a reverse polarity to that of the charged toner, in order to transfer the toner images formed on the surface portions of the photoreceptors 92y, 92m, 92c, and 92k onto the recording medium 82 carried by the transferring belt 91.

The driving roller 102 is a roller-shaped member which can rotate by a driving mechanism (not shown). The driving roller 102 drives the conveying belt 91 so as to move around. The driving roller 102 is controlled by the control portion realized by CPU.

The driven roller 103 is a roller-shaped member which is provided so as to be driven by the rotation of the conveying belt 91 and which functions as a tension roller that gives a predetermined tension to the conveying belt 91.

The charge-removing portion 104 is provided on a downstream side of the pressure-contact area between the photoreceptor 92k and the transferring roller 101k and on an upstream side of the most closely located area between the conveying belt 91 and the fixing unit 89 when viewed in a rotary direction of the conveying belt 91, that is, in the arrow 91a direction. To the charge-removing portion 104 is applied the alternating current voltage by an alternating current voltage applying section (not shown) so that charges of the conveying belt 91 are removed, which causes the recording medium 82 electrostatically attracted on the conveying belt 91 to be more easily detached from the conveying belt 91 and moreover causes the recording medium 82 to be smoothly fed from the conveying belt 91 to the fixing unit 89.

In the transferring unit 88, the toner images of respective colors formed on the photoreceptors 92y, 92m, 92c, and 92k are transferred onto predetermined positions of the recording medium 82 carried by the conveying belt 91 so that the toner images are combined with each other, thus resulting in a multicolor-toner image. The recording medium 82 thus carrying thereon the multicolor toner image is then led to the fixing unit 89.

The fixing unit 89 includes a heating roller 105 and a pressurizing roller 110. The heating roller 105 can rotate about a shaft center thereof by a driving mechanism (not shown). Inside the heating roller 105 is provided a heating portion such as a halogen lamp. The pressurizing roller 106 is provided in pressure-contact with the heating roller 105 so as to be rotatable by a driving mechanism (not shown) or driven by the rotation of the heating roller 105. The recording medium 82 carrying the multicolor toner image is transferred by the conveying belt 91 to the pressure-contact area between the heating roller 106 and the pressurizing roller 106, in which heat and pressure are applied to the multicolor toner image, with the result that the multicolor toner image is fixed on the recording medium 82.

In the fixing unit 89, the recording medium 82 carrying the multicolor toner image is heated under pressure in the contact area between the heating roller 105 and the pressurizing roller 106, whereby the multicolor toner image is fixed on the recording medium 82. The recording medium 82 on which the multicolor toner image has been thus fixed by the fixing unit 89 is then conveyed to the paper discharging unit 90 in the image forming apparatus 81.

The paper discharging unit 90 includes a catch tray 107 and paper discharging rollers 108a and 108b. The catch tray 107 is disposed outside a casing of the image forming apparatus 81, and stores therein the toner-image-fixed recording medium 82 discharged from the image forming apparatus 81. The paper discharging rollers 108a and 108b are disposed inside the image forming apparatus 81, near a paper discharging port (not shown) formed in the casing of the image forming apparatus 81, and serve to discharge the toner-image-fixed recording medium 82 conveyed from the fixing unit 89, to the outside of the image forming apparatus 81 and then put the toner-image-fixed recording medium 82 on the catch tray 107. By using the paper discharging unit 90, the toner-image-fixed recording medium 82 is discharged to the catch tray 107 disposed outside the image forming apparatus 81.

In the image forming section 83, the toner images of respective colors corresponding to image information are formed on the surface portions of the photoreceptors 92y, 92m, 92c and 92k, and then transferred onto the recording medium 82 carried on the conveying belt 91 so that the toner images are combined, thus forming a multicolor toner image which is then fixed on the recording medium 82 in the fixing unit 89. The recording medium 82 on which the multicolor toner image has been fixed, is subsequently discharged to the catch tray 107.

The paper feeding section 84 includes a recording medium cassette 109, a pickup roller 110, a registration roller 111, and a recording-medium conveying roller 112. The recording medium cassette 109 stores the recording medium 82, for example, ordinary paper sheets of various sizes such as B5, B4, A4 or A3, recording paper for use in color copy, etc., and overhead projector sheets (OHP sheets). The pickup roller 110 feeds the recording medium 82 housed in the recording medium cassette 109, sheet by sheet to a conveyance path P. The registration roller 111 feeds the recording medium 82 onto the conveying belt 91 in synchronization with the conveyance of the toner image from the photoreceptor 92y to the transfer position, i.e., the pressure-contact area between the photoreceptor 92y and the transfer roller 101y. The registration roller 111 feeds the recording medium 82 to the transfer position. The recording medium conveying roller 112 assists the conveyance of the recording medium 82 to the registration roller 111 in the conveyance path P. In a case where images are formed on both sides of the recording medium 82, a toner image is firstly fixed on one surface of the recording medium 82 in the fixing unit 89, and then the recording medium 82 is fed to the image forming section 83 by way of a conveyance path A, a conveyance path B, a conveyance path C, and a conveyance path D so that a toner image is transferred on also the other surface of the recording medium 82 and fixed thereon. A conveyance direction of the recording medium 82 fed to the conveyance path A is inverted so that the recording medium 82 will be led toward the conveyance path C. By using the paper feeding section 84, the recording medium 82 is fed onto the conveying belt 91 sheet by sheet in synchronization with the conveyance of the toner image from the photoreceptor 92y to the transfer position, that is, the pressure-contact area between the photoreceptor 92y and the transferring roller 101y.

The image reading section 86 includes the document table 85, a first document scanning unit 113, a second document scanning unit 114, an optical lens 115, and a CCD (charge coupled device) line sensor 116.

The document table 85 is provided with a document placement surface of which top face is supported so as to be openable and closable with respect to the document table 85 and oh which the document is placed. The document may be manually placed on the document table 85 and alternatively, the document may be placed on the document table 85 by an automatic document feeder (not shown).

The first document scanning unit 113 is provided so as to move back and forth in parallel at a constant scanning speed with a constant distance kept from a lower surface of the document table 85. The first document scanning unit 113 includes an exposure lamp for exposing the surface portion of the document image, and a first mirror for deflecting a light image reflected by the document toward the second document scanning unit 114.

The second document scanning unit 114 is provided so as to move back and forth in parallel to the first document scanning unit 113 at a speed having a constant relation with the speed of the first document scanning unit 113. The second document scanning unit 114 includes second mirror and third mirror for further deflecting the light image which has been reflected by the document and deflected by the first mirror of the first document scanning unit 113, toward the optical lens 115.

The optical lens 115 reduces the size of an image light reflected by the document, which light image has been deflected by the third mirror of the second document scanning unit 114, and leads the light image thus reduced in size, to a predetermined position on the CCD line sensor 116, thereby forming an image thereon. The CCD line sensor 116 photoelectrically converts the formed light image one after another into an electric signal which is then outputted. The CCD line sensor 116 reads a monochrome image or a color image, and converts the image information into electric signals of respective colors which are then outputted to the exposing units 94y, 94m, 94c, and 94k, respectively.

In the image reading section 8.6, the image information is read from the document placed on the document table 85, and the image information thus read is converted into electric signals of respective colors which are then outputted to the exposing units 94y, 94m, 94c, and 94k.

In the image forming apparatus 81, the toner images of respective colors are formed on the basis of the image information read in the image reading section 86, and the toner images are transferred and fixed onto the recording medium 82 to form thereon an image based on the original document.

In the embodiment, the image forming apparatus 81 employs a direct transfer system that the toner images are directly transferred from the photoreceptors 92y, 92m, 92c, and 92k onto the recording medium 82. A system employed in the image forming apparatus 81 is not limited to the direct transfer system, and the image forming apparatus 81 may also employ an intermediate transfer system that the toner image on a photoreceptor is once transferred onto an intermediate transfer medium such as an intermediate transfer belt and thereafter the toner image thus transferred onto the intermediate transfer medium is transferred onto a recording medium.

Since the toner of the invention is used as a toner in the image forming apparatus, the image forming apparatus exhibits a quick rise of charging and excellent cleaning property, thus enabling to form high-quality images having high definition and high density.

### EXAMPLES

The invention will be specifically described with reference to the following Examples and Comparative examples.

In Examples and Comparative examples, a degree of circularity, a weight average particle diameter, glass transition temperature (Tg) and softening temperature (Tm) of the binder resin, and the melting temperature of the release agent were determined as follows.

[Degree of Circularity]

First of all, dispersion was prepared by dispersing 5 mg of a toner into 10 ml of water in which about 0.1 mg of a surfactant had been dissolved, and the dispersion was irradiated for five minutes with ultrasound having frequency of 20 kHz and output of 50 W. Assuming that a concentration of toner particles contained in the dispersion was 5,000 to 20,000 pieces/μL, the degree of circularity was measured by the above-stated flow particle image analyzer: FPIA-3000 manufactured by Sysmex Corporation. Further, on the basis of a measurement result of the degree of circularity, an average degree of circularity was calculated in the above formula (4).

[Weight Average Particle Diameter]

The weight average particle diameter based on volume was determined by a Coulter Multisizer II (trade name) manufactured by Beckman Coulter, Inc. with use of a volume distribution obtained under the following conditions.

Aperture diameter: 50 μm

Analysis software: Coulter Multisizer AccuComp 1.19 version (manufactured by Beckman Coulter, Inc.)

Electrolyte: ISOTON II (manufactured by Beckman Coulter, Inc.)

Dispersion: 5% EMULGEN 109P (polyoxyethylene lauryl ether HLB 13.6 manufactured by Kao Corporation)

Electrolyte-dispersing conditions: 10 mg of a measurement sample was added to 5 ml of the dispersion and dispersed therein for one minute by an ultrasonic disperser, followed by addition of 25 ml of the electrolyte and further dispersion for one minute in the ultrasonic disperser.

Measurement conditions: 100 ml of the electrolyte and the dispersion were put in a beaker and under such a concentration condition that 20 seconds were required to measure 30,000 particles, diameters of particles were measured for 20 seconds.

[Glass Transition Temperature (Tg) of Binder Resin]

Using a differential scanning calorimeter: DSC220 (trade name) manufactured by Seiko electronics Inc., 1 g of a sample was heated at a temperature of which increase rate was 10° C./min based on Japanese Industrial Standards (JIS) K7121-1987, thus obtaining a DSC curve. A straight line was drawn toward a low-temperature side extendedly from a base line on the high-temperature side of an endothermic peak corresponding to glass transition of the DSC curve which had been obtained as above. A tangent line was also drawn at a point where a gradient thereof was maximum against a curve extending from a rising part to a top of the peak. A temperature at an intersection of the straight line and the tangent line was determined as the glass transition temperature (Tg).

[Softening Temperature (Tm) of Binder Resin]

Using a device for evaluating flow characteristics: Flow tester CFT-100C (trade name) manufactured by Shimadzu Corporation, 1 g of a sample was heated at a temperature of which increase rate was 6° C./min, under load of 10 kgf/cm² (9.8×10⁵ Pa) so that the sample was pushed out of a die (nozzle). A temperature of the sample at the time when a half of the sample had flowed out of the die was determined as the softening temperature of the binder resin. Note that the die was 1 mm in opening diameter and 1 mm in length.

[Melting Temperature of Release Agent]

Using the differential scanning calorimeter: DSC220 (trade name) manufactured by Seiko electronics Inc., 1 g of a sample was heated from a temperature of 20° C. up to 150° C. at a temperature of which increase rate was 10° C./min, and then an operation of rapidly cooling down the sample from 150° C. to 20° C. was repeated twice, thus obtaining a DSC curve. A temperature obtained at a top of an endothermic peak which corresponds to the melting shown on the DSC curve obtained at the second operation, was determined as the melting temperature of the release agent.

### Example 1

A toner raw material was mixed for 10 minutes by a Henschel mixer: FM mixer (trade name) manufactured by Mitsui Mining Co. The toner row material contained, as indicated by combination ratios (part by weight), 83 parts by weight of polyester which serves as binder resin Tafton TTR-5 (trade name) manufactured by Kao Corporation, having a glass transition temperature (Tg) of 60° C. and a softening temperature (Tm) of 100° C.; 12 parts by weight of master batch containing as a colorant 40% by weight of C.I. pigment red 57:1; 3 parts by weight of carnauba wax which serves as a release agent. Refined carnauba wax (trade name) manufactured by S. KATO & Co., having a melting temperature of 83° C.; and 2 parts by weight of alkyl salicylate metal salt which serves as a charge control agent: Bontron E-84 (trade name) manufactured by Orient Co., Ltd.

A thus-obtained admixture of raw material was melt-kneaded by Kneadics MOS140-800 (trade name) manufactured by Mitsui Mining Co. and cooled down to a room temperature. And then, a solidified matter of melt-kneaded material thus obtained was coarsely pulverized by a coarsely pulverizing device: Orient VM-27 manufactured by Seishin Kikaku Co., Ltd. Conditions for the melt-kneading operation were set as follows. A temperature on a supply side of a front roll was set at 75° C., a temperature on a discharge side of the front roll 50° C., temperatures on a supply side and a discharge side of a back roll 20° C., a rotation speed of the front roll 75 rpm (75 rotations per minute), a rotation speed of the back roll 60 rpm, and a speed of supplying the toner raw material 10 kg per hour. A temperature of the toner raw material measured by an infrared noncontact thermometer during the melt-kneading operation was 120° C. or less at any kneading points. Subsequently, a coarsely pulverized matter obtained by coarsely pulverizing the solidified matter of the melt-kneaded material was finely pulverized by a counter jet mill AFG manufactured by Hosokawa Micron Co., thus resulting in a pulverized material of resin composition.

Next, a hot-air-type spheronizing device: Meteo Rainbow (trade name) manufactured by Nippon Pneumatic MFG. Co., Ltd. was used to treat the pulverized material of resin composition with the spheronization process. In the hot-air-type spheronizing device, air volume for supply and dispersion of the pulverized material was set at 0.2 Nm per minute with air pressure of 2×10⁴ Pa, an input amount of the pulverized material 3.0 kg per hour, volume of the hot air 0.5 Nm³ per minute with air pressure of 4×10⁴ Pa, a temperature of the hot air 190° C., and a temperature of cooled air 5° C. The pulverized material of resin composition was thus formed into the spherical shape, resulting in spheronized resin particles.

The spheronized resin particles thus formed are classified by air to obtain toner particles. A weight average particle diameter of thus-obtained toner particles was 6.7 μm. To 100 parts by weight of the toner particles were added 0.2 parts by weight of hydrophobic silica: R-974 (trade name) manufactured by Nippon Aerosil Co., Ltd., and 0.3 parts by weight of hydrophobic titanium: T-805 (trade name) manufactured by Nippon Aerosil Co., Ltd. An admixture thus obtained was mixed by the Henschel mixer, thus resulting in a toner of Example 1.

### Example 2

A toner of Example 2 was obtained in the same manner as Example 1 except that a device: Kryptron KTM-X type (trade name) manufactured by Earth Technica Co., Ltd., equivalent to the impact-type spheronizing device shown in FIG. 6, was used to form into the spherical shape the pulverized material of resin composition obtained in the same manner as Example 1. In the impact-type spheronizing device, an input amount of the pulverized material was set at 45 kg per hour, a rotation speed of a dispersing rotor 13,000 rpm, and a clearance d3 between the dispersing rotor and a stator 2.0 mm. A temperature of gas which was discharged together with the toner particles from a toner particle outlet, was 35° C. that was equal to or lower than the glass transition temperature of the binder resin.

### Example 3

A toner of Example 3 was obtained in the same manner as Example 1 except that a device: Faculty F-600 type (trade name) manufactured by Hosokawa Micron Corporation, equivalent to the impact-type spheronizing device shown in FIG. 4, was used to form into the spherical shape the pulverized material of resin composition obtained in the same manner as Example 1 and that no classification was carried out. In the impact-type spheronizing device, an input amount of the pulverized material was set at 4 kg for one time, and fine particles were removed under the condition that a rotation speed of a classifying rotor was set at 5,000 rpm, while cooled air flowing from a cooled air inlet into a treatment tank was set at 4° C., and the spheronization process was carried out for two minutes (120 seconds) under the condition that a rotation speed of a dispersing rotor was set at 5,800 rpm. A temperature of gas which was discharged together with the fine particles from a fine particle outlet, was 38° C. that was equal to or lower than the glass transition temperature of the binder resin.

### Example 4

A toner of Example 3 was obtained in the same manner as Example 1 except that a device: Kryptron KTM-X type (trade name) manufactured by Earth Technica Co., Ltd., equivalent to the impact-type spheronizing device shown in FIG. 6, was used to form into the spherical shape the pulverized material of resin composition obtained in the same manner as Example 1. In the impact-type spheronizing device, an input amount of the pulverized material was set at 35 kg per hour, a rotation speed of a dispersing rotor 10,000 rpm, and a clearance d3 between the dispersing rotor and a stator 2.5 mm. A temperature of gas which was discharged together with the toner particles from a toner particle outlet, was 31° C. that was equal to or lower than the glass transition temperature of the binder resin.

### Comparative Example 1

A toner of Comparative example 1 was obtained in the same manner as Example 1 except that the temperature of the hot air was changed to 230° C.

### Comparative Example 2

A toner of Comparative example 2 was obtained in the same manner as Example 1 except that the pulverized material of resin composition obtained in the same manner as Example 1 were not treated with the spheronization process before classified.

With 5 parts by weight of toners of Example and Comparative example, 95 parts by weight of ferrite core carrier having a volume average particle diameter 45 μm was mixed as a carrier for 20 minutes by a V-shaped mixer: V-5 (trade name) manufactured by Tokuju Kosakusho Co., Ltd. A two-component developer having a toner concentration of 5% by weight was thus fabricated. A carrier envelope degree of the ferrite core carrier was 2.3.

Cleaning properties after images were formed with the two-component developer containing the toners of Examples and Comparative examples, respectively, were evaluated in the following manner, as well as charging start-up properties of the toners of Examples and Comparative examples, respectively.

<Cleaning Property>

A commercially-available copier: AR-C 150 manufactured by Sharp Corporation was filled up with the two-component developer containing the toners obtained in Examples and Comparative examples, respectively. By using such a copier, charts were continuously printed on A4-sized recording sheets which are defined in accordance with Japanese Industrial Standards (JIS) P0138. Note that a print ratio of the chart was 5%. After 30,000 sheets were printed, a test chart was formed. Three types of the test chart were formed, i.e., an entirely solid image, a thin line chart, and blank (of 0% print ratio). Image defects of these three types of the test charts were checked with eyes for evaluation. Evaluation criteria were as follows.

Good: Favorable. No image defects were found in any of the three types of the test charts.

Available: No problem in practical use. Some image defects were found in one or more types of the test charts, which cause no problem in practical use.

Poor: Unusable in practice. Some image defects were found in one or more types of the test charts.

<Charging Start-Up Property>

Into a polyethylene-made cylindrical container having a bottom was put 40 g of the two-component developer containing the toners obtained in Examples and Comparative examples. A capacity of the container was 100 ml. The container was then made to rotate about an axial line thereof at a speed of 60 rpm. A charge amount was measured at time points after a lapse of 0.25 min, 0.5 min, 1 min, 2 min, 3 min, 5 min, 10 min, 15 min, 30 min, 60 min, and 120 min, respectively, after a start of the rotation. For the measurement of the charge amount was used a small-sized suction type charge measurement system: Model 210HS-2A manufactured by Trek Japan K.K. The maximum value among values of charge amount measured after the respective times have passed, was defined as Qm. A length of time until the charge amount reached 90% or more of the value Qm, was defined as a charging start-up time. It can be noted that the shorter the charging start-up time is, the more favorable the charging start-up property is. Evaluation criteria are as follows.

Good: Favorable. The charging start-up time was 5 minutes or less.

Available: No problem in practical use. The charging start-up time was more than 5 minutes and 10 minutes or less.

Poor: Unusable in practice. The charging start-up time exceeds 10 minutes

<Comprehensive Evaluation>

Evaluation criteria of comprehensive evaluation are as follows.

Very good: Very favorable. No Available or Poor was given in the evaluation result of the cleaning property and the charging start-up property.

Good: Favorable. No Poor but one Available was given in the evaluation result of the cleaning property and the charging start-up property.

Available: No problem in practical use. All evaluations given for the cleaning property and the charging start-up property were Available.

Poor: Defective. All evaluations. given for the cleaning property and the charging start-up property were Poor.

A table 1 shows the envelope degree, average degree of circularity, weight average particle diameter, evaluation results of cleaning property, evaluation results of charging start-up property, and comprehensive evaluation results of the toner particles of Examples and Comparative examples. In Table 1, Examples 1 to 4 and Comparative examples 1 and 2 are stated in ascending order of the envelope degree.

TABLE 1

| | | | | Weight | | | |
|---|---|---|---|---|---|---|---|
| | | | Average | average | | | |
| | | | degree | particle | | Charging | |
| | Spheronization | Envelope | of | diameter | Cleaning | start-up | Comprehensive |
| | process | degree | circularity | (μm) | property | property | evaluation |
| Comp. | Meteo | 1.95 | 0.975 | 6.89 | Poor | Available | Poor |
| ex. 1 | Rainbow | | | | | | |
| | (Hot air temp.: | | | | | | |
| | 230° C.) | | | | | | |
| Ex. 1 | Meteo | 2.00 | 0.965 | 6.84 | Available | Good | Good |
| | Rainbow | | | | | | |
| | (Hot air temp.: | | | | | | |
| | 190° C.) | | | | | | |
| Ex. 2 | Kryptron | 2.35 | 0.960 | 6.68 | Good | Good | Very Good |
| | (Rotor rotation | | | | | | |
| | speed: 13000 rpm) | | | | | | |
| Ex. 3 | Faculty | 2.45 | 0.957 | 6.55 | Good | Good | Very Good |
| Ex. 4 | Kryptron | 3.00 | 0.955 | 6.72 | Good | Available | Good |
| | (Rotor rotation | | | | | | |
| | speed: 10000 rpm) | | | | | | |
| Comp. | Not performed | 3.48 | 0.951 | 6.70 | Good | Poor | Poor |
| ex. 2 | | | | | | | |

Table 1 clearly shows that the toner of the invention exhibits a quick rise of charging and excellent cleaning property, which enables formation of high-definition images.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A toner which is formed of toner particles containing binder resin and a colorant, the toner satisfying the following formula (1):
2.0≦[(L1−L2)/L2]×100≦3.0 (1)
wherein L1 represents a circumference length of a projection image of the toner particles, and L2 represents a length of envelope of the projection image of the toner particles.

2. The toner of claim 1, wherein the toner particles exhibit an average degree of circularity of 0.980 or less.

3. The toner of claim 1, wherein the toner is an electrophotographic toner.

4. A developer comprising the toner of claim 1 and a carrier.

5. The developer of claim 4, wherein the following formula (2) is satisfied:
[(C1−C2)/C2]×100≦3.0 (2)
wherein C1 represents a circumference length of a projection image of the carrier, and C2 represents a length of envelope of the projection image of the carrier.

6. The developer of claim 4, wherein the developer is an electrophotographic developer.

7. An image forming apparatus which uses the toner of claim 1 to form an image.
